(19) United States
(12) Patent Application Publication
(10) Pub. No.: US 2018/0095559 A1
(43) Pub. Date: Apr. 5, 2018

(54) Display Panel, Display Device, Input/Output Device, and Data Processing Device

(71) Applicant: Semiconductor Energy Laboratory Co., Ltd., Kanagawa-ken (JP)

(72) Inventors: Shunpei Yamazaki, Tokyo (JP); Shingo Eguchi, Atsugi (JP); Hisao Ikeda, Zama (JP); Daisuke Kubota, Atsugi (JP); Fumito Isaka, Zama (JP)

(73) Assignee: Semiconductor Energy Laboratory Co., Ltd., Kanagawa-ken (JP)

(21) Appl. No.: 15/718,434

(22) Filed: Sep. 28, 2017

(30) Foreign Application Priority Data
Sep. 30, 2016 (JP) 2016-193458

(51) Int. Cl. G06F 3/044; G02F 1/1333; G02F 1/1335; G02F 1/1362; G06F 3/041

(52) U.S. Cl. CPC G06F 3/044; G02F 1/13338; G02F 1/133526; G02F 1/1368; G02F 1/133345; G02F 1/136286; G06F 3/0416; G02F 1/133553

(57) ABSTRACT

To provide a novel display panel with high convenience or high reliability. The display panel includes a pixel including a functional layer, a first display element, and a second display element. The functional layer includes a pixel circuit and includes a region positioned between the first and second display elements. The pixel circuit is electrically connected to the first and second display elements. The first display element includes a reflective film and is configured to control the intensity of light reflected by the reflective film. The reflective film has a shape that does not block light emitted from the second display element. The second display element includes a light-emitting element and is provided such that display using the second display element can be seen from part of a region where display using the first display element can be seen.

### BACKGROUND OF THE INVENTION

### 1. Field of the Invention

Embodiments of the present invention relate to a display panel, a display device, an input/output device, and a data processing device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method for driving any of them, and a method for manufacturing any of them.

### 2. Description of the Related Art

The following liquid crystal display devices are known: a liquid crystal display device in which a light-condensing means and a pixel electrode are provided on the same surface side of a substrate and a region transmitting visible light in the pixel electrode is provided to overlap with an optical axis of the light-condensing means; and a liquid crystal display device that includes an anisotropic light-condensing means having a condensing direction X and a non-condensing direction Y that is along the longitudinal direction of a region transmitting visible light in the pixel electrode (Patent Document 1).

The structure is known in which a region that reflects incident light through a liquid crystal layer to perform display (reflective region) and a region through which light from a backlight passes to perform display (transmissive region) are provided in one pixel, and an image can be displayed in both modes: the reflective mode where external light is used as an illumination light source; and the transmissive mode where the backlight is used as an illumination light source (Patent Document 2). In addition, two transistors connected to respective pixel electrode layers are provided in one pixel, and the two transistors are separately operated, whereby display in the reflective region and display in the transmissive region can be controlled independently.

### REFERENCE

[Patent Document]

[Patent Document 1] Japanese Published Patent Application No. 2011-191750

[Patent Document 2] Japanese Published Patent Application No. 2011-154356

### SUMMARY OF THE INVENTION

An object of one embodiment of the present invention is to provide a novel display panel with high convenience or high reliability. Another object is to provide a novel display device with high convenience or high reliability. Another object is to provide a novel input/output device with high convenience or high reliability. Another object is to provide a novel data processing device with high convenience or high reliability. Another object is to provide a novel display panel, a novel display device, a novel input/output device, a novel data processing device, or a novel semiconductor device.

Note that the description of these objects does not disturb the existence of other objects. In one embodiment of the present invention, there is no need to achieve all the objects. Other objects will be apparent from and can be derived from the description of the specification, the drawings, the claims, and the like.

(1) One embodiment of the present invention is a display panel including a pixel.

The pixel includes a functional layer, a first display element, and a second display element.

The functional layer includes a pixel circuit and includes a region positioned between the first display element and the second display element.

The pixel circuit is electrically connected to the first display element and the second display element.

The first display element includes a reflective film and is configured to control intensity of light reflected by the reflective film. The reflective film has a shape that does not block light emitted from the second display element.

The second display element includes a light-emitting element and is provided such that display using the second display element can be seen from part of a region where display using the first display element can be seen. Note that a light-emitting diode can be used as the second display element.

With such a structure, display can be performed by controlling the intensity of light reflected by the reflective film with the use of the first display element. Alternatively, display using the first display element can be complemented using a light-emitting diode as the second display element. Consequently, a novel display panel with high convenience or high reliability can be provided.

(2) Another embodiment of the present invention is the above display panel in which the pixel includes an optical element and a covering film.

The optical element has a light-transmitting property and includes a first region, a second region, and a third region.

The first region includes a region to which light is supplied, the second region includes a region in contact with the covering film, and the third region is configured to emit part of the light and has an area smaller than or equal to an area of the region of the first region to which the light is supplied.

The covering film has light reflectivity and is configured to reflect the part of the light and supply the part of the light to the third region.

The reflective film has a shape that does not block light emitted from the third region of the optical element.

The second display element is configured to supply the light.

(3) Another embodiment of the present invention is the above display panel in which the optical element has an optical axis.

The optical axis passes through a center of a region of the first region to which the light is supplied and a center of the third region. The second region includes an inclined portion with an inclination of 45° or more with respect to a plane orthogonal to the optical axis.

With such a structure, display can be performed by controlling the intensity of light reflected by the reflective film with the use of the first display element. Alternatively, display using the first display element can be complemented using the second display element. Alternatively, the light supplied to the first region can be efficiently emitted from the third region. Alternatively, the light supplied to the first region can be gathered and emitted from the third region. For example, an area of the light-emitting diode used as the second display element can be larger than an area of the third region. Alternatively, light supplied from the light-emitting diode having an area larger than the area of the third region can be gathered in the third region. Alternatively, density of a current supplied to the light-emitting diode can be decreased while the intensity of light emitted from the third region is maintained. Alternatively, reliability of the light-emitting diode can be increased. Consequently, a novel display panel with high convenience or high reliability can be provided.

(4) Another embodiment of the present invention is the above display panel further including a lens.

The lens includes a region positioned between the optical element and the second display element, includes a material with a refractive index of 1.5 or more and 2.5 or less, and is a convex lens.

With such a structure, light emitted from the second display element can be gathered toward the optical axis of the optical element, for example. Alternatively, light emitted from the second display element can be used efficiently. Alternatively, the density of a current supplied to the light-emitting diode can be decreased. Alternatively, the area of the second display element can be increased. Alternatively, the reliability of the light-emitting diode can be increased. Consequently, a novel display panel with high convenience or high reliability can be provided.

(5) Another embodiment of the present invention is the above display panel in which the pixel includes a first conductive film, a second conductive film, and an insulating film.

The insulating film includes a region positioned between the first conductive film and the second conductive film. The insulating film has an opening.

The first conductive film is electrically connected to the first display element.

The second conductive film includes a region overlapping with the first conductive film, is electrically connected to the first conductive film in the opening, and is electrically connected to the pixel circuit.

The second display element is electrically connected to the pixel circuit and is configured to emit light toward the insulating film.

(6) Another embodiment of the present invention is the above display panel including a display region.

The display region includes one group of pixels, another group of pixels, a scan line, and a signal line.

The one group of pixels include the pixel. The pixels of the one group are arranged in a row direction.

The another group of pixels include the pixel. The pixels of the another group are arranged in a column direction intersecting with the row direction.

The scan line is electrically connected to the one group of pixels. The signal line is electrically connected to the another group of pixels.

Thus, the first display element and the second display element that displays an image by a method different from that of the first display element can be driven using pixel circuits that can be formed in the same process. Furthermore, with the insulating film, impurity diffusion between the first display element and the second display element or between the first display element and the pixel circuit can be inhibited.

Consequently, a novel display device with high convenience or high reliability can be provided.

(7) Another embodiment of the present invention is a display device including the above display panel and a control portion.

The control portion is configured to receive image data and control data, generate first data and second data on the basis of the image data, and supply the first data and the second data.

The display panel is configured to receive the first data and the second data.

The first display element is configured to display an image on the basis of the first data, and the second display element is configured to display an image on the basis of the second data.

With such a structure, image data can be displayed using the first display element. Furthermore, image data can be displayed using the second display element. Furthermore, image data can be displayed using the second display element such that the image data overlaps with the image data displayed using the first display element. Furthermore, the image data displayed using the first display element can be complemented using the second display element. Consequently, a novel display device with high convenience or high reliability can be provided.

(8) Another embodiment of the present invention is an input/output device including an input portion and a display portion.

The display portion includes the above display panel.

The input portion includes a sensing region and is configured to sense an object approaching the sensing region.

The sensing region includes a region overlapping with the pixel.

(9) Another embodiment of the present invention is the above input/output device in which the sensing region includes a control line, a sensor signal line, and a sensor element.

The sensor element is electrically connected to the control line and the sensor signal line.

The control line is configured to supply a control signal. The sensor signal line is configured to receive a sensor signal.

The sensor element is configured to supply the sensor signal that varies in accordance with the control signal and a distance between a region overlapping with the pixel and an object approaching the region. The sensor element includes a first electrode and a second electrode.

The first electrode includes a light-transmitting region in the region overlapping with the pixel and is electrically connected to the control line.

The second electrode includes a light-transmitting region in the region overlapping with the pixel and is electrically connected to the sensor signal line. The second electrode is located such that an electric field part of which is blocked by an object approaching the region overlapping with the pixel is generated between the second electrode and the first electrode.

With such a structure, an object approaching the region overlapping with the display portion can be sensed while image data is displayed by the display portion. Alternatively, a finger or the like that approaches the display portion can be used as a pointer to input positional data. Alternatively, positional data can be associated with image data displayed on the display portion. Consequently, a novel input/output device with high convenience or high reliability can be provided.

(10) Another embodiment of the present invention is a data processing device including at least one of a keyboard, a hardware button, a pointing device, a touch sensor, an illuminance sensor, an imaging device, an audio input device, a viewpoint input device, and an attitude determination device, and the above display panel.

With such a structure, the arithmetic device can generate the image data or the control data on the basis of the data supplied using a variety of input devices. Consequently, a novel data processing device with high convenience or high reliability can be provided.

Although the block diagram attached to this specification shows components classified by their functions in independent blocks, it is difficult to classify actual components according to their functions completely and it is possible for one component to have a plurality of functions.

In this specification, the terms “source” and “drain” of a transistor interchange with each other depending on the polarity of the transistor or the levels of potentials supplied to the terminals. In general, in an n-channel transistor, a terminal to which a lower potential is supplied is called a source, and a terminal to which a higher potential is supplied is called a drain. In a p-channel transistor, a terminal to which a lower potential is supplied is called a drain, and a terminal to which a higher potential is supplied is called a source. In this specification, although the connection relation of the transistor is described assuming that the source and the drain are fixed for convenience in some cases, actually, the names of the source and the drain interchange with each other depending on the relation of the potentials.

In this specification, a “source” of a transistor means a source region that is part of a semiconductor film functioning as an active layer or a source electrode connected to the semiconductor film. Similarly, a “drain” of a transistor means a drain region that is part of the semiconductor film or a drain electrode connected to the semiconductor film. A “gate” means a gate electrode.

In this specification, a state in which transistors are connected to each other in series means, for example, a state in which only one of a source and a drain of a first transistor is connected to only one of a source and a drain of a second transistor. In addition, a state in which transistors are connected in parallel means a state in which one of a source and a drain of a first transistor is connected to one of a source and a drain of a second transistor and the other of the source and the drain of the first transistor is connected to the other of the source and the drain of the second transistor.

In this specification, the term “connection” means electrical connection and corresponds to a state where current, voltage, or potential can be supplied or transmitted. Accordingly, connection means not only direct connection but also indirect connection through a circuit element such as a wiring, a resistor, a diode, or a transistor so that current, potential, or voltage can be supplied or transmitted.

In this specification, even when different components are connected to each other in a circuit diagram, there is actually a case where one conductive film has functions of a plurality of components, such as a case where part of a wiring serves as an electrode. The term “connection” also means such a case where one conductive film has functions of a plurality of components.

Further, in this specification, one of a first electrode and a second electrode of a transistor refers to a source electrode and the other refers to a drain electrode.

One embodiment of the present invention can provide a novel display panel with high convenience or high reliability. Another embodiment can provide a novel display device with high convenience or high reliability. Another embodiment can provide a novel input/output device with high convenience or high reliability. Another embodiment can provide a novel data processing device with high convenience or high reliability. Another embodiment can provide a novel display panel, a novel display device, a novel input/output device, a novel data processing device, or a novel semiconductor device.

Note that the description of these effects does not preclude the existence of other effects. One embodiment of the present invention does not necessarily have all the effects listed above. Other effects will be apparent from and can be derived from the description of the specification, the drawings, the claims, and the like.

### BRIEF DESCRIPTION OF THE DRAWINGS

FIGS. 1A to 1D are schematic views illustrating the structure of a pixel in a display panel of an embodiment.

FIGS. 2A and 2B are cross-sectional views illustrating the structure of a pixel in a display panel of an embodiment.

FIGS. 3A and 3B are cross-sectional views illustrating the structure of a pixel in a display panel of an embodiment.

FIGS. 4A to 4C are top views and a cross-sectional view illustrating the structure of a display panel of an embodiment.

FIGS. 5A and 5B are cross-sectional views illustrating the structure of a display panel of an embodiment.

FIGS. 6A and 6B are cross-sectional views illustrating the structure of a display panel of an embodiment.

FIG. 7 is a bottom view illustrating the structures of pixels in a display panel of an embodiment.

FIG. 8 is a circuit diagram illustrating a pixel circuit in a display panel of an embodiment.

FIGS. 9A to 9D are cross-sectional views illustrating the structures of reflective films of display panels of embodiments.

FIGS. 10A to 10C are top views illustrating pixels and subpixels of display panels of embodiments.

FIG. 11 is a top view illustrating pixels and subpixels in a display panel of an embodiment.

FIGS. 12A1, 12A2, 12B1, 12B2, 12C1, 12C2, 12D1, 12D2, 12E1, 12E2, 12F1, and 12F2 are cross-sectional views and perspective views illustrating the shapes of optical elements of display panels of embodiments.

FIGS. 13A and 13B are block diagrams illustrating the structure of a display device using a display panel of an embodiment.

FIGS. 14A, 14B1, 14B2, and 14B3 are a block diagram and perspective views illustrating the structures of display panels of embodiments.

FIG. 15 is a block diagram illustrating the structure of an input/output device of an embodiment.

FIGS. 16A to 16C are top views illustrating the structure of an input/output device of an embodiment.

FIGS. 17A and 17B are cross-sectional views illustrating the structure of an input/output device of an embodiment.

FIG. 18 is a cross-sectional view illustrating the structure of an input/output device of an embodiment.

FIG. 19 is a cross-sectional view illustrating the structure of an input/output device of an embodiment.

FIGS. 20A to 20C are a block diagram and projection views illustrating the structures of data processing devices of embodiments.

FIGS. 21A and 21B are flow charts each showing a driving method of a data processing device of an embodiment.

FIG. 22 is a flow chart showing a driving method of a data processing device of an embodiment.

FIGS. 23A and 23B illustrate the structure of a module of an embodiment.

FIGS. 24A to 24E illustrate the structures of data processing devices of embodiments.

FIGS. 25A to 25E illustrate the structures of data processing devices of embodiments.

FIGS. 26A to 26C illustrate the structures of electronic devices of embodiments.

### DETAILED DESCRIPTION OF THE INVENTION

A display panel of one embodiment of the present invention includes a pixel. The pixel includes a functional layer, a first display element, and a second display element. The functional layer includes a pixel circuit and includes a region positioned between the first display element and the second display element. The pixel circuit is electrically connected to the first display element and the second display element. The first display element includes a reflective film and is configured to control the intensity of light reflected by the reflective film. The reflective film has a shape that does not block light emitted from the second display element. The second display element includes a light-emitting diode and is provided such that display using the second display element can be seen from part of a region where display using the first display element can be seen.

With such a structure, display can be performed by controlling the intensity of light reflected by the reflective film with the use of the first display element. Furthermore, display using the first display element can be complemented using a light-emitting diode as the second display element. Consequently, a novel display panel with high convenience or high reliability can be provided.

Embodiments will be described in detail with reference to the drawings. Note that the present invention is not limited to the following description. It will be readily appreciated by those skilled in the art that modes and details of the present invention can be modified in various ways without departing from the spirit and scope of the present invention. Thus, the present invention should not be construed as being limited to the description of the following embodiments. Note that in structures of the invention described below, the same portions or portions having similar functions are denoted by the same reference numerals in different drawings, and the description thereof is not repeated.

### Embodiment 1

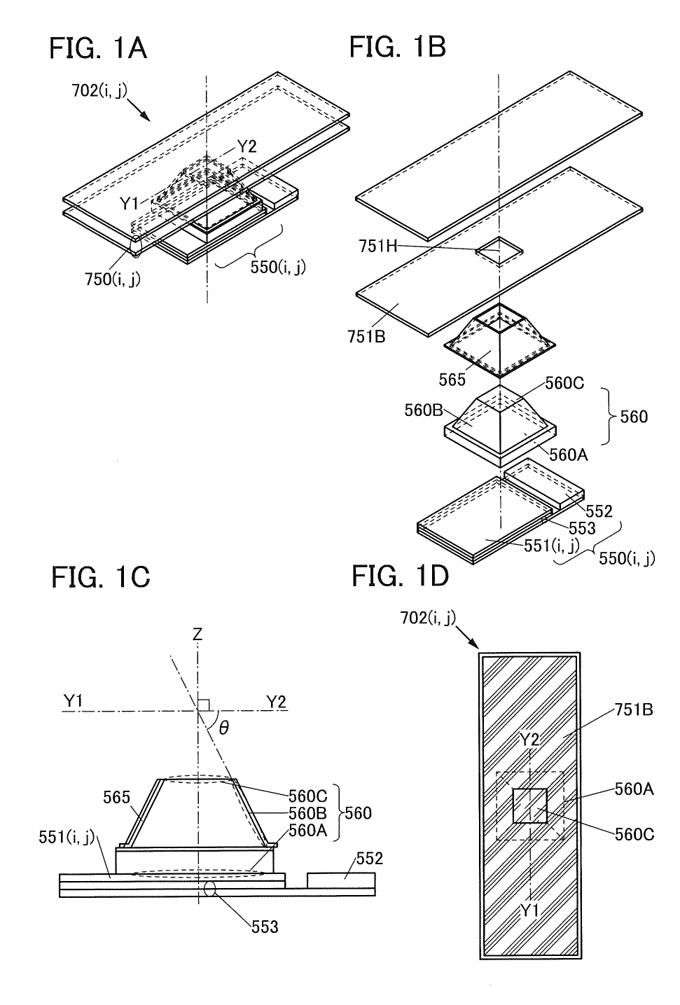

In this embodiment, the structure of a display panel of one embodiment of the present invention will be described with reference to FIGS. 1A to 1D to FIG. 8.

FIGS. 1A to 1D illustrate the structure of the display panel of one embodiment of the present invention. FIG. 1A is a projection view of a pixel, and FIG. 1B is an exploded view for illustrating part of the structure of the pixel in FIG. 1A. FIG. 1C is a cross-sectional view that is taken along line Y1-Y2 in FIG. 1A and for illustrating part of the structure of the pixel. FIG. 1D is a top view of the pixel in FIG. 1A.

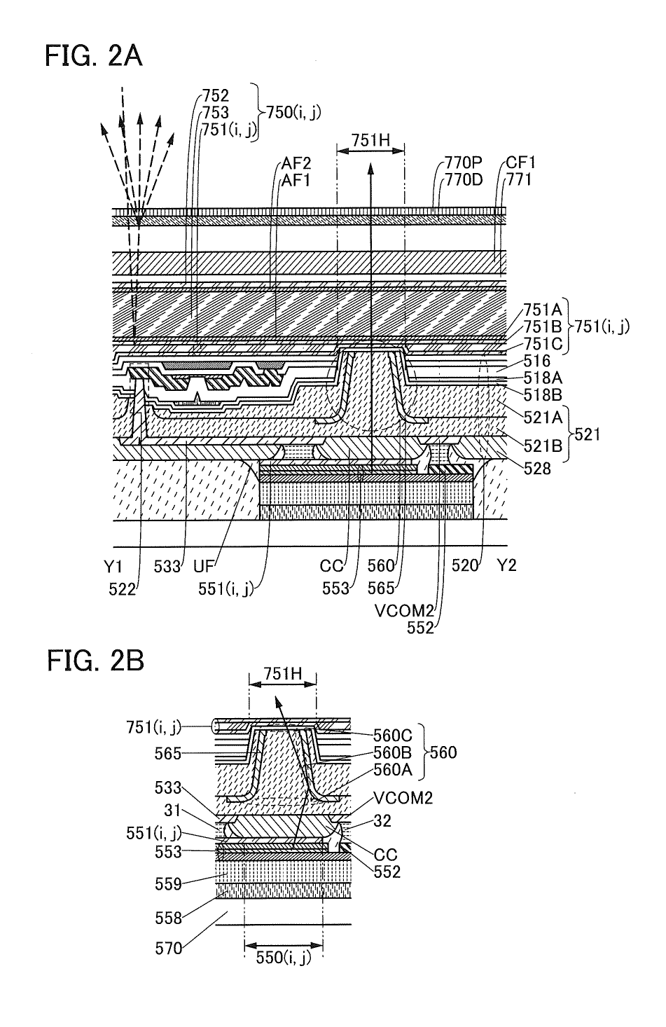

FIGS. 2A and 2B illustrate the structure of the display panel of one embodiment of the present invention. FIG. 2A is a cross-sectional view of the pixel taken along line Y1-Y2 in FIG. 1A. FIG. 2B is a cross-sectional view illustrating part of the structure of the pixel in FIG. 2A.

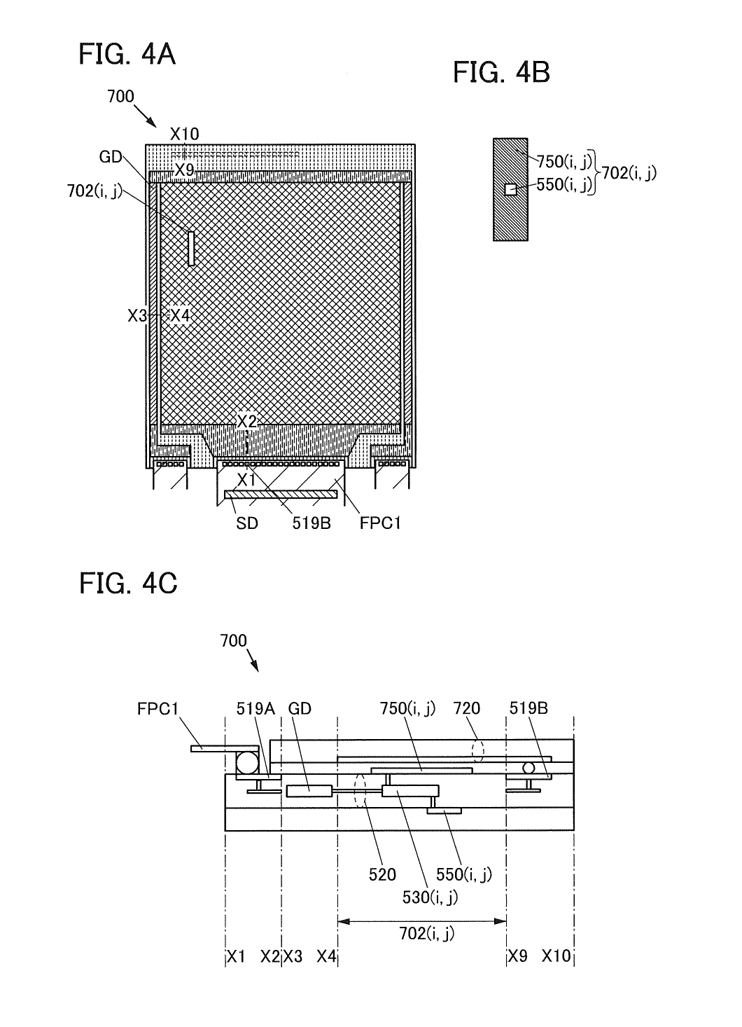

FIGS. 4A to 4C illustrate the structure of the display panel of one embodiment of the present invention. FIG. 4A is a top view of the display panel. FIG. 4B is a top view illustrating part of the pixel of the display panel in FIG. 4A. FIG. 4C is a schematic view illustrating a cross-sectional structure of the display panel in FIG. 4A.

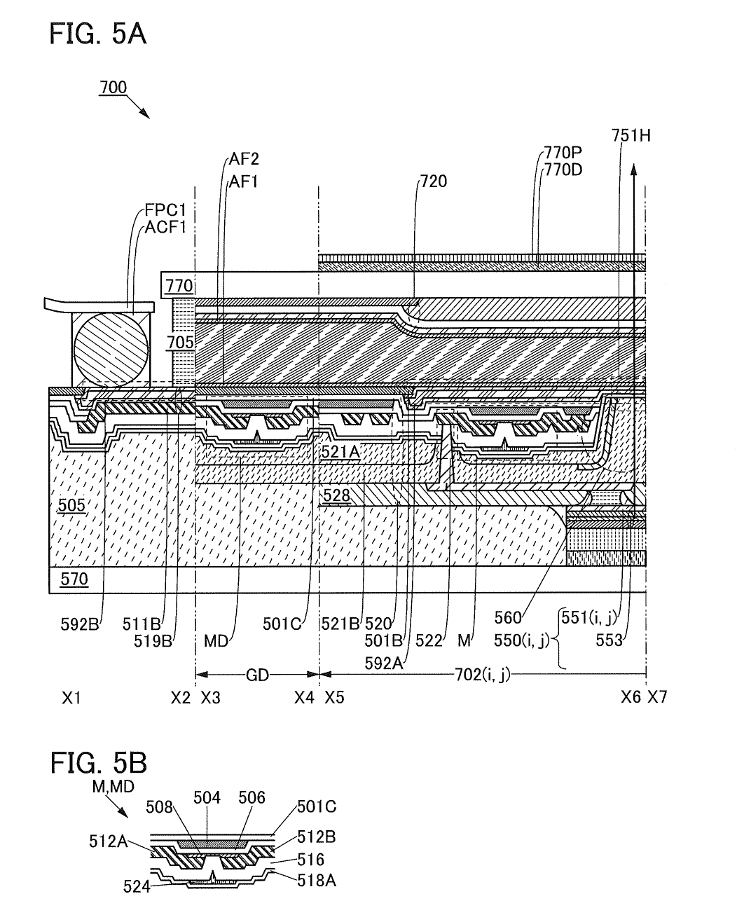

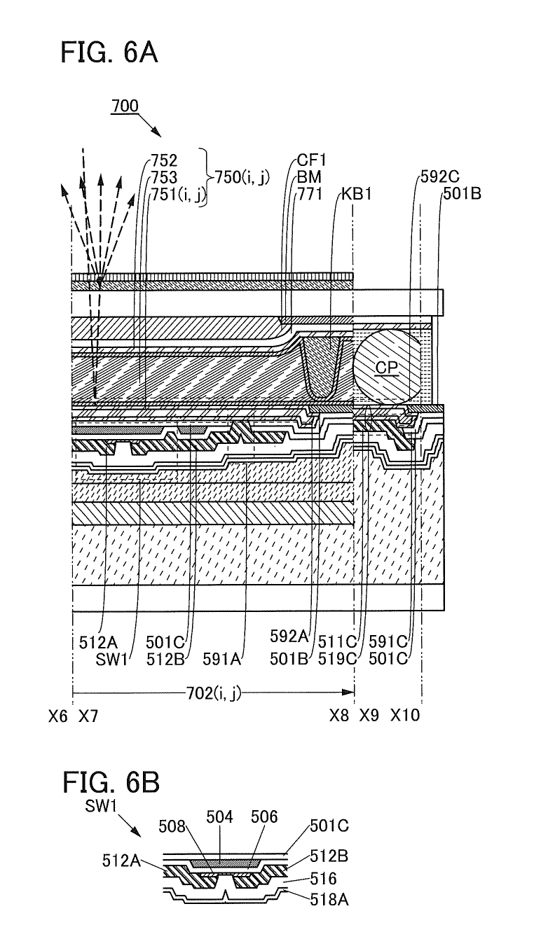

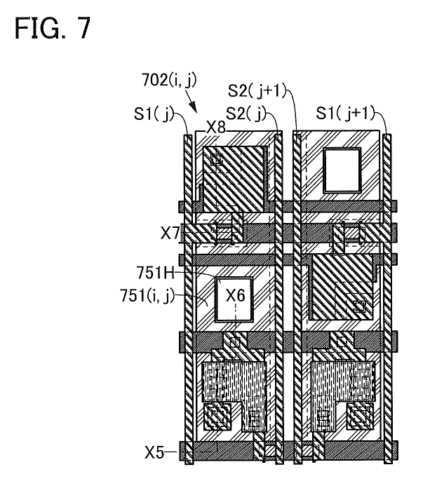

FIGS. 5A and 5B and FIGS. 6A and 6B are cross-sectional views illustrating the structure of the display panel. FIG. 5A is a cross-sectional view taken along line X1-X2 and line X3-X4 in FIG. 4A, and line X5-X6 in FIG. 7. FIG. 5B illustrates part of FIG. 5A.

FIG. 6A is a cross-sectional view taken along line X7-X8 in FIG. 7 and line X9-X10 in FIG. 4A. FIG. 6B illustrates part of FIG. 6A.

FIG. 7 is a bottom view illustrating some pixels of the display panel in FIG. 4A.

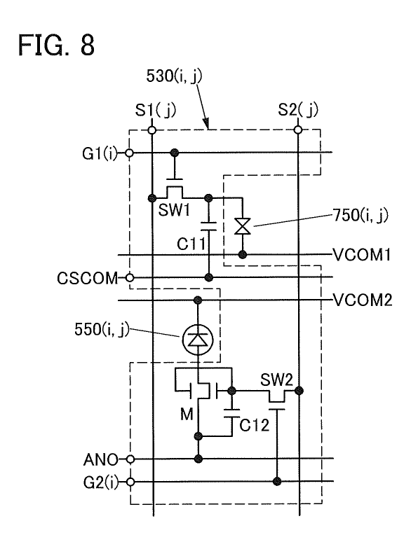

FIG. 8 is a circuit diagram illustrating the configuration of a pixel circuit included in a display panel of one embodiment of the present invention.

Note that in this specification, an integral variable of 1 or more may be used for reference numerals. For example, “(p)” where p is an integral value of 1 or more may be used for part of a reference numeral that specifies any one of components (up to p components). For another example, “(m,n)” where m and n are each an integral value of 1 or more may be used for part of a reference numeral that specifies any one of components (up to m×n components).

### <Structural Example 1 of Display Panel>

A display panel 700 described in this embodiment includes a pixel 702(i,j) (see FIG. 4A).

### <<Structural Example 1 of Pixel>>

The pixel 702(i,j) includes a functional layer 520, a first display element 750(i,j), and a second display element 550(i,j) (see FIG. 4C).

The functional layer 520 includes a pixel circuit 530(i,j). The functional layer 520 includes a region positioned between the first display element 750(i,j) and the second display element 550(i,j).

The pixel circuit 530(i,j) is electrically connected to the first display element 750(i,j) and the second display element 550(i,j).

<<Structural Example 1 of First Display Element 750(i,j)>>

The first display element 750(i,j) includes a reflective film 751B and has a function of controlling the intensity of light reflected by the reflective film 751B (see FIGS. 1A and 1B). The reflective film 751B has a shape that does not block light emitted from the second display element 550(i,j). For example, the reflective film 751B can have a shape including a region 751H where light is not blocked.

<<Structural Example 1 of Second Display Element 550(i,j)>>

The second display element 550(i,j) is provided such that display using the second display element 550(i,j) can be seen from part of a region where display using the first display element 750(i,j) can be seen (see FIG. 1A). For example, a light-emitting diode can be used as the second display element 550(i,j). Specifically, the second display element 550(i,j) includes an electrode 551(i,j), an electrode 552, and a multilayer film 553. For example, a light-emitting diode with a horizontal structure or a vertical structure can be used as the second display element 550(i,j).

With such a structure, display can be performed by controlling the intensity of light reflected by the reflective film with the use of the first display element.

Furthermore, display using the first display element can be complemented using a light-emitting diode as the second display element. Consequently, a novel display panel with high convenience or high reliability can be provided.

### <<Structural Example 2 of Pixel>>

The pixel 702(i,j) includes an optical element 560 and a covering film 565.

### <<Structural Example 1 of Optical Element>>

The optical element 560 has a light-transmitting property and includes a first region 560A, a second region 560B, and a third region 560C (see FIGS. 1B and 1C and FIG. 2B).

The first region 560A includes a region to which light is supplied. For example, the first region 560A receives light from the second display element 550(i,j).

The second region 560B includes a region in contact with the covering film 565.

The third region 560C has a function of allowing part of light to be extracted and has an area smaller than or equal to the area of the region of the first region 560A to which light is supplied.

### <<Structural Example of Covering Film>>

The covering film 565 has light reflectivity and has a function of reflecting part of light and supplying it to the third region 560C. For example, the covering film 565 can reflect light emitted from the second display element 550(i,j) toward the third region 560C. Specifically, part of light incident on the optical element 560 through the first region 560A can be reflected by the covering film 565 in contact with the second region 560B and extracted from the third region 560C, as shown by a solid arrow (see FIG. 2B).

<<Structural Example 2 of First Display Element 750(i,j)>>

The reflective film 751B has a shape that does not block light extracted from the third region 560C of the optical element 560.

<<Structural Example 2 of Second Display Element 550(i,j)>>

The second display element 550(i,j) has a function of supplying light (see FIG. 1B and FIG. 2A). For example, the second display element 550(i,j) has a function of supplying light to the first region 560A.

With such a structure, display can be performed by controlling the intensity of light reflected by the reflective film with the use of the first display element. Alternatively, display using the first display element can be complemented using the second display element. Alternatively, the light supplied to the first region can be efficiently emitted from the third region. Alternatively, the light supplied to the first region can be gathered and emitted from the third region. For example, the area of the light-emitting diode used as the second display element can be larger than the area of the third region. Alternatively, light supplied from the light-emitting diode having an area larger than the area of the third region can be gathered in the third region. Alternatively, the density of a current supplied to the light-emitting diode can be decreased while the intensity of light emitted from the third region is maintained. Alternatively, the reliability of the light-emitting diode can be increased. Consequently, a novel display panel with high convenience or high reliability can be provided.

Note that the second display element 550(i,j) includes a support 559. For example, a single crystal substrate such as a sapphire substrate can be used for the support 559. Alternatively, a material that reflects light or a material with thermal conductivity can be used for the support 559. Specifically, a material to which the multilayer film 553 separated from a sapphire substrate or the like is transferred can be used for the support 559.

The display panel 700 of one embodiment of the present invention can include a heat dissipation material 558 between the second display element 550(i,j) and a substrate 570. This enables heat generated by driving of the second display element 550(i,j) to be dissipated to the substrate 570.

Specifically, a composite material including a resin and inorganic material particles can be used for the heat dissipation material 558. For example, for the resin, an epoxy resin or a silicone resin can be used. For the inorganic material particles, aluminum nitride, boron nitride, aluminum oxide, magnesium oxide, silicon oxide, or magnesium hydroxide can be used, for example.

### <<Structural Example 3 of Pixel>>

The pixel 702(i,j) includes part of the functional layer 520, a first display element 750(i,j), and a second display element 550(i,j) (see FIG. 4C).

### <<Functional Layer 520>>

The functional layer 520 includes a first conductive film, a second conductive film, an insulating film 501C, and the pixel circuit 530(i,j). The functional layer 520 includes the optical element 560 and the covering film 565 (see FIG. 2A and FIG. 5A). The pixel circuit 530(i,j) includes a transistor M, for example.

The functional layer 520 includes an insulating film 528, an insulating film 521A, an insulating film 521B, an insulating film 518A, an insulating film 518B, and an insulating film 516.

### <<Pixel Circuit>>

The pixel circuit 530(i,j) has a function of driving the first display element 750(i,j) and the second display element 550(i,j) (see FIG. 8).

Thus, the first display element and the second display element that displays an image by a method different from that of the first display element can be driven using pixel circuits that can be formed in the same process. Specifically, a reflective display element is used as the first display element, whereby power consumption can be reduced. Alternatively, an image with high contrast can be favorably displayed in an environment with bright external light. Alternatively, an image can be favorably displayed in a dark environment with the use of the second display element which emits light. Alternatively, with the insulating film, impurity diffusion between the first display element and the second display element or between the first display element and the pixel circuit can be inhibited. Consequently, a novel display device with high convenience or high reliability can be provided.

A switch, a transistor, a diode, a resistor, an inductor, a capacitor, or the like can be used in the pixel circuit 530(i,j).

For example, one or a plurality of transistors can be used as a switch. Alternatively, a plurality of transistors connected in parallel, in series, or in combination of parallel connection and series connection can be used as a switch.

For example, the pixel circuit 530(i,j) is electrically connected to a signal line S1(j), a signal line S2(j), a scan line G1(i), a scan line G2(i), a wiring CSCOM, and a conductive film ANO (see FIG. 8). Although not illustrated, a conductive film 512A is electrically connected to the signal line S1(j).

The pixel circuit 530(i,j) includes a switch SW1 and a capacitor C11 (see FIG. 8).

The pixel circuit 530(i,j) includes a switch SW2, a transistor M, and a capacitor C12.

For example, a transistor including a gate electrode electrically connected to the scan line G1(i) and a first electrode electrically connected to the signal line S1(j) can be used as the switch SW1.

The capacitor C11 includes a first electrode electrically connected to a second electrode of the transistor used as the switch SW1 and a second electrode electrically connected to the wiring CSCOM.

For example, a transistor including a gate electrode electrically connected to the scan line G2(i) and a first electrode electrically connected to the signal line S2(j) can be used as the switch SW2.

The transistor M includes a gate electrode electrically connected to a second electrode of the transistor used as the switch SW2 and a first electrode electrically connected to the conductive film ANO.

Note that a transistor including a conductive film provided such that a semiconductor film is positioned between a gate electrode and the conductive film can be used as the transistor M. For example, as the conductive film, a conductive film electrically connected to a wiring that can supply the same potential as that of the gate electrode of the transistor M can be used.

The capacitor C12 includes a first electrode electrically connected to the second electrode of the transistor used as the switch SW2 and a second electrode electrically connected to the first electrode of the transistor M.

A first electrode of the first display element 750(i,j) is electrically connected to the second electrode of the transistor used as the switch SW1. A second electrode of the first display element 750(i,j) is electrically connected to a wiring VCOM1. This enables the first display element 750 to be driven.

The electrode 551(i,j) and the electrode 552 of the second display element 550(i,j) are electrically connected to a second electrode of the transistor M and a conductive film VCOM2, respectively. This enables the second display element 550(i,j) to be driven.

### <<Insulating Film 501C>>

The insulating film 501C includes a region positioned between the first conductive film and the second conductive film and has an opening 591A (see FIG. 6A). In addition, the insulating film 501C has an opening 591C.

### <<First Conductive Film>>

The first conductive film is electrically connected to the first display element 750(i,j). Specifically, the first conductive film is electrically connected to an electrode 751(i,j) of the first display element 750(i,j). The electrode 751(i,j) can be used as the first conductive film.

### <<Second Conductive Film>>

The second conductive film includes a region overlapping with the first conductive film. The second conductive film is electrically connected to the first conductive film through the opening 591A. For example, a conductive film 512B can be used as the second conductive film.

Note that the first conductive film electrically connected to the second conductive film in the opening 591A formed in the insulating film 501C can be referred to as a through electrode.

The second conductive film is electrically connected to the pixel circuit 530(i,j). For example, a conductive film that functions as a source electrode or a drain electrode of a transistor used as a switch SW1 of the pixel circuit 530(i,j) can be used as the second conductive film.

<<Structural Example 3 of Second Display Element 550(i,j)>>

The second display element 550(i,j) is electrically connected to the pixel circuit 530(i,j) (see FIG. 5A and FIG. 8). The second display element 550(i,j) has a function of emitting light toward the functional layer 520. The second display element 550(i,j) has a function of emitting light toward the insulating film 501C or an opening formed in the insulating film 501C, for example.

The second display element 550(i,j) is provided such that display using the second display element 550(i,j) can be seen from part of a region where display using the first display element 750(i,j) can be seen. For example, dashed arrows shown in FIG. 6A denote the directions in which external light is incident on and reflected by the first display element 750(i,j) that displays image data by controlling the intensity of external light reflection. In addition, a solid arrow shown in FIG. 5A denotes the direction in which the second display element 550(i,j) emits light to part of the region where display using the first display element 750(i,j) can be seen.

Accordingly, display using the second display element can be seen from part of the region where display using the first display element can be seen. Alternatively, users can see display without changing the attitude or the like of the display panel. Alternatively, an object color expressed by light reflected by the first display element and a light source color expressed by light emitted from the second display element can be mixed. Alternatively, an object color and a light source color can be used to display an image like a painting. Thus, a novel display panel with high convenience or high reliability can be provided.

For example, the second display element 550(i,j) includes the electrode 551(i,j), the electrode 552, and the multilayer film 553 (see FIG. 2A or FIG. 5A).

The electrode 551(i,j) is electrically connected to the pixel circuit 530(i,j) at a connection portion 522. Specifically, the electrode 551(i,j) is electrically connected to the pixel circuit 530(i,j) through a conductive material 31 and a conductive film 533 (see FIGS. 2A and 2B and FIG. 4B).

The electrode 552 is electrically connected to the conductive film VCOM2. Specifically, the electrode 552 is electrically connected to the conductive film VCOM2 through a conductive material 32.

Note that a diffusion bonding method can be used for electrical connection between an electrode and a conductive film. Thus, the electrode 551(i,j) can be electrically connected to the conductive film 533 without using the conductive material 31, and the electrode 552 can be electrically connected to the conductive film VCOM2 without using the conductive material 32.

A sealing material UF can be provided between the second display element 550(i,j) and the insulating film 528. This can prevent a defect such as separation of the second display element 550(i,j) from the insulating film 528.

### <<Insulating Films 521, 528, 518A, 518B, and 516>>

An insulating film 521 includes a region positioned between the pixel circuit 530(i,j) and the second display element 550(i,j) (see FIGS. 2A and 2B and FIG. 4B).

For example, a laminated film can be used as the insulating film 521. For example, a stack of the insulating film 521A and the insulating film 521B can be used as the insulating film 521.

The insulating film 528 includes a region positioned between the insulating film 521 and the substrate 570 and has an opening in a region overlapping with the second display element 550(i,j). The insulating film 528 that is along the edge of the electrode 551(i,j) can avoid a short circuit between the electrode 551(i,j) and the electrode 552.

The insulating film 518A includes a region positioned between the insulating film 521 and the pixel circuit 530(i,j). For example, the insulating film 518A includes a region positioned between the insulating film 521 and the transistor M. The insulating film 518B includes a region positioned between the optical element 560 and the region 751H.

The insulating film 516 includes a region positioned between the insulating film 518A and the pixel circuit 530(i,j). For example, the insulating film 516 includes a region positioned between the insulating film 518A and the transistor M.

Furthermore, the display panel 700 can include an insulating film 501B. The insulating film 501B has an opening 592A, an opening 592B, and an opening 592C (see FIG. 5A and FIG. 6A).

The opening 592A includes a region overlapping with the electrode 751(i,j) and a region overlapping with the insulating film 501C.

The opening 592B includes a region overlapping with a conductive film 511B (see FIG. 5A).

The opening 592C includes a region overlapping with a conductive film 511C (see FIG. 6A).

### <Structural Example 2 of Display Panel>

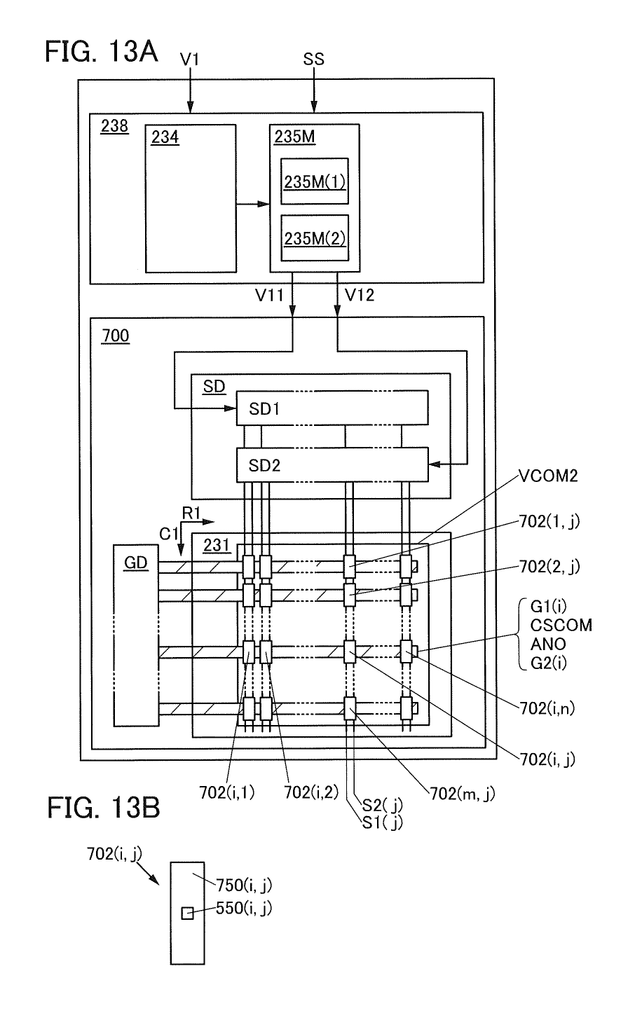

The display panel 700 described in this embodiment includes a display region 231 (see FIG. 13A).

### <<Display Region 231>>

The display region 231 includes one group of pixels 702(i,1) to 702(i,n), another group of pixels 702(1,j) to 702(m,j), a scan line G1(i), and a signal line S1(j) (see FIG. 13A). The display region 231 includes the scan line G2(i), the wiring CSCOM, the conductive film ANO, and the signal line S2(j). Note that i is an integer greater than or equal to 1 and less than or equal to m, j is an integer greater than or equal to 1 and less than or equal to n, and each of m and n is an integer greater than or equal to 1.

The one group of pixels 702(i,1) to 702(i,n) include the pixel 702(i,j) and are arranged in the row direction (the direction indicated by the arrow R1 in the drawing).

The another group of pixels 702(1,j) to 702(m,j) include the pixel 702(i,j) and are arranged in the column direction (the direction indicated by the arrow C1 in the drawing) that intersects the row direction.

The scan line G1(i) and the scan line G2(i) are electrically connected to the group of pixels 702(i,1) to 702(i,n) arranged in the row direction.

The signal line S1(i) and the signal line S2(j) are electrically connected to the another group of pixels 702(1,j) to 702(m,j) arranged in the column direction.

### <Structural Example 3 of Display Panel>

The display panel 700 described in this embodiment can include a plurality of pixels having functions of representing colors with different hues. Furthermore, colors with hues that cannot be represented by the plurality of pixels capable of representing colors with different hues can be represented by additive color mixing with the use of the pixels.

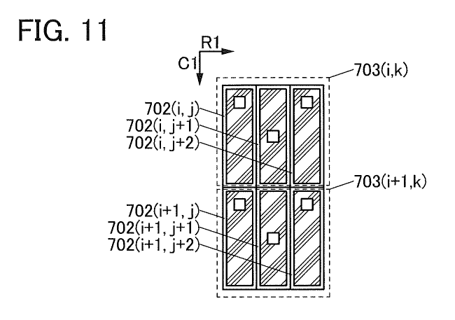

Note that when a plurality of pixels capable of representing colors with different hues are used for color mixture, each of the pixels can be referred to as a subpixel. In addition, a set of subpixels can be referred to as a pixel. Specifically, the pixel 702(i,j) can be referred to as a subpixel, and the pixel 702(i,j) a pixel 702(i,j+1), and a pixel 702(i,j+2) can be collectively referred to as a pixel 703(i,k) (see FIG. 11).

For example, a subpixel that represents blue, a subpixel that represents green, and a subpixel that represents red can be collectively used as the pixel 703(i,k).

Alternatively, for example, a subpixel that represents cyan, a subpixel that represents magenta, and a subpixel that represents yellow can be collectively used as the pixel 703(i,k).

Alternatively, for example, the above set to which a subpixel that represents white is added can be used as the pixel.

Alternatively, for example, a set of the following subpixels can be used as the pixel 703(i,k): a subpixel including the first display element 750(i,j) that represents cyan and the second display element 550(i,j) that represents blue; a subpixel including a first display element 750(i,j+1) that represents yellow and a second display element 550(i,j+1) that represents green; and a subpixel including a first display element 750(i,j+2) that represents magenta and a second display element 550(i,j+2) that represents red. This allows bright display using the first display elements 750(i,j) to 750(i,j+2) or clear display using the second display elements 550(i,j) to 550(i,j+2).

### <Structural Example 4 of Display Panel>

The display panel 700 described in this embodiment can include a driver circuit GD or a driver circuit SD (see FIG. 4A and FIG. 13A).

### <<Driver Circuit GD>>

The driver circuit GD has a function of supplying a selection signal on the basis of control data.

For example, the driver circuit GD has a function of supplying a selection signal to one scan line at a frequency of 30 Hz or higher, preferably 60 Hz or higher, on the basis of control data. Accordingly, moving images can be smoothly displayed.

For example, the driver circuit GD has a function of supplying a selection signal to one scan line at a frequency of lower than 30 Hz, preferably lower than 1 Hz, more preferably less than once per minute, on the basis of control data. Accordingly, a still image can be displayed with reduced flickering.

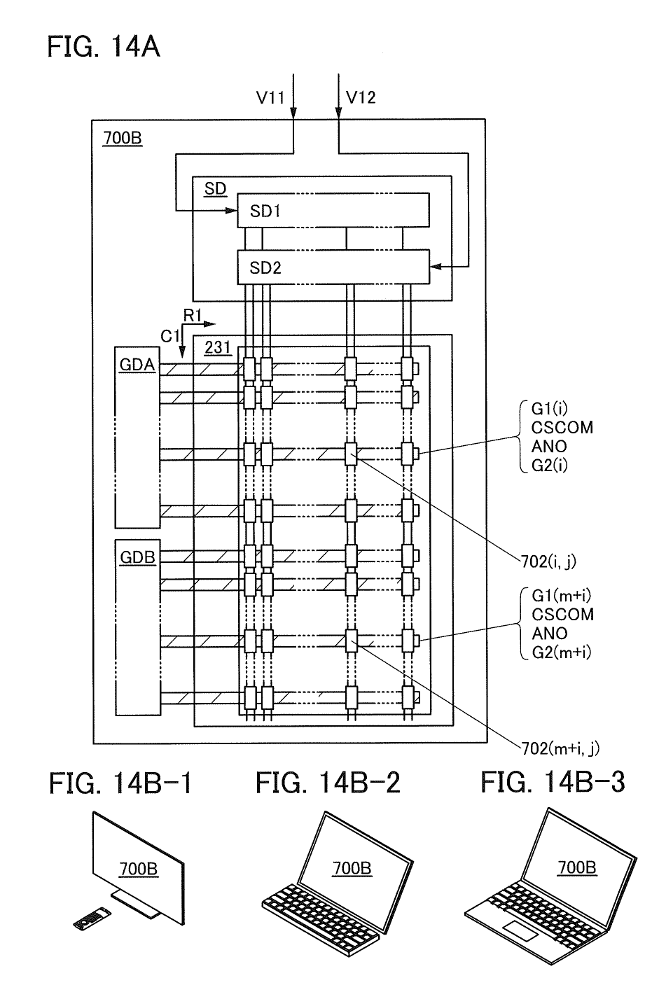

A display panel can include a plurality of driver circuits. For example, a display panel 700B includes a driver circuit GDA and a driver circuit GDB (see FIG. 14A).

For example, in the case where a plurality of driver circuits are provided, the driver circuits GDA and GDB may supply the selection signals at different frequencies. Specifically, the selection signal can be supplied at a higher frequency to a region on which moving images are displayed than to a region on which a still image is displayed. Accordingly, a still image can be displayed in a region with reduced flickering, and moving images can be smoothly displayed in another region.

### <<Driver Circuit SD>>

The driver circuit SD includes a driver circuit SD1 and a driver circuit SD2. The driver circuit SD1 has a function of supplying an image signal on the basis of the data V11. The driver circuit SD2 has a function of supplying an image signal on the basis of the data V12 (see FIG. 13A).

The driver circuit SD1 or the driver circuit SD2 has a function of generating an image signal and a function of supplying the image signal to a pixel circuit electrically connected to a display element. Specifically, the driver circuit SD1 or the driver circuit SD2 has a function of generating a signal whose polarity is inverted. Thus, for example, a liquid crystal display element can be driven.

For example, any of a variety of sequential circuits, such as a shift register, can be used as the driver circuit SD.

For example, an integrated circuit in which the driver circuit SD1 and the driver circuit SD2 are integrated can be used as the driver circuit SD. Specifically, an integrated circuit formed on a silicon substrate can be used as the driver circuit SD.

An integrated circuit can be mounted on a terminal by a chip on glass (COG) method or a chip on film (COF) method, for example. Specifically, an anisotropic conductive film can be used to mount an integrated circuit on the terminal.

### <Structural Example 5 of Display Panel>

Moreover, the display panel 700 described in this embodiment includes a functional layer 720, a terminal 519B, a terminal 519C, the substrate 570, a substrate 770, a bonding layer 505, a sealing material 705, a structure body KB1, a functional film 770P, a functional film 770D, and the like (see FIG. 5A and FIG. 6A).

### <<Functional Layer 720>>

The functional layer 720 includes a region positioned between the substrate 770 and the insulating film 501C. The functional layer 720 includes a light-blocking film BM, an insulating film 771, and a coloring film CF1 (see FIG. 5A and FIG. 6A).

The light-blocking film BM has an opening in a region overlapping with the first display element 750(i,j) (see FIG. 6A).

The coloring film CF1 includes a region positioned between the substrate 770 and the first display element 750(i,j).

The insulating film 771 includes a region between the coloring film CF1 and the layer 753 containing a liquid crystal material and a region between the light-blocking film BM and the layer 753 containing a liquid crystal material. The insulating film 771 can reduce unevenness due to the thickness of the coloring film CF1. Alternatively, impurities can be prevented from being diffused from the light-blocking film BM, the coloring film CF1, or the like to the layer 753 containing a liquid crystal material.

### <<Terminals 519B and 519C>>

The display panel described in this embodiment includes a terminal 519B and a terminal 519C (see FIG. 5A and FIG. 6A).

The terminal 519B includes the conductive film 511B. The terminal 519B is electrically connected to the signal line S1(j), for example.

The terminal 519C includes the conductive film 511C. The conductive film 511C is electrically connected to the wiring VCOM1, for example.

A conductive material CP is sandwiched between the terminal 519C and the electrode 752, and has a function of electrically connecting the terminal 519C and the electrode 752. For example, a conductive particle can be used as the conductive material CP.

### <<Substrate 570 and Substrate 770>>

In addition, the display panel described in this embodiment includes the substrate 570 and the substrate 770.

The substrate 770 includes a region overlapping with the substrate 570. The substrate 770 includes a region positioned such that the functional layer 520 is sandwiched between the substrate 770 and the substrate 570.

The substrate 770 includes a region overlapping with the first display element 750(i,j). For example, a material with low birefringence can be used for the region.

### <<Bonding Layer 505, Sealing Material 705, and Structure Body KB1>>

The display panel described in this embodiment includes the bonding layer 505, the sealing material 705, and the structure body KB1.

The bonding layer 505 includes a region positioned between the functional layer 520 and the substrate 570, and has a function of bonding the functional layer 520 and the substrate 570 to each other.

The sealing material 705 includes a region positioned between the functional layer 520 and the substrate 770, and has a function of bonding the functional layer 520 and the substrate 770 to each other.

The structure body KB1 has a function of providing a certain space between the functional layer 520 and the substrate 770.

### <<Functional Films 770P and 770D>>

The display panel described in this embodiment includes the functional film 770P and the functional film 770D.

The functional film 770P includes a region overlapping with the first display element 750(i,j).

The functional film 770D includes a region overlapping with the first display element 750(i,j). The functional film 770D is provided such that a substrate 770 lies between the functional film 770D and the first display element 750(i,j). Thus, for example, light reflected by the first display element 750(i,j) can be diffused.

### <Example of Components>

The display panel 700 includes the substrate 570, the substrate 770, the structure body KB1, the sealing material 705, and the bonding layer 505.

The display panel 700 also includes the functional layer 520, the optical element 560, the covering film 565, the insulating film 521, and the insulating film 528.

The display panel 700 also includes the signal line S1(j), the signal line S2(j), the scan line G1(i), the scan line G2(i), the wiring CSCOM, and the conductive film ANO.

The display panel 700 also includes the first conductive film and the second conductive film.

The display panel 700 also includes the terminal 519B, the terminal 519C, the conductive film 511B, and the conductive film 511C.

The display panel 700 also includes the pixel circuit 530(i,j) and the switch SW1.

The display panel 700 also includes the first display element 750(i,j), the electrode 751(i,j), the reflective film, the opening, the layer 753 containing a liquid crystal material, and the electrode 752.

The display panel 700 also includes an alignment film AF1, an alignment film AF2, the coloring film CF1, the light-blocking film BM, the insulating film 771, the functional film 770P, and the functional film 770D.

The display panel 700 also includes the second display element 550(i,j), the electrode 551(i,j), the electrode 552, and the multilayer film 553.

The display panel 700 also includes the insulating film 501B and the insulating film 501C.

The display panel 700 also includes the driver circuit GD and the driver circuit SD.

### <<Substrate 570>>

The substrate 570 or the like can be formed using a material having heat resistance high enough to withstand heat treatment in the manufacturing process. For example, a material with a thickness greater than or equal to 0.1 mm and less than or equal to 0.7 mm can be used for the substrate 570. Specifically, a material polished to a thickness of approximately 0.1 mm can be used.

For example, a large-sized glass substrate having any of the following sizes can be used as the substrate 570 or the like: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large-sized display device can be manufactured.

For the substrate 570 or the like, an organic material, an inorganic material, a composite material of an organic material and an inorganic material, or the like can be used. For example, an inorganic material such as glass, ceramic, or metal can be used for the substrate 570 or the like.

Specifically, non-alkali glass, soda-lime glass, potash glass, crystal glass, aluminosilicate glass, tempered glass, chemically tempered glass, quartz, sapphire, or the like can be used for the substrate 570 or the like. Specifically, an inorganic oxide film, an inorganic nitride film, an inorganic oxynitride film, or the like can be used for the substrate 570 or the like. For example, a silicon oxide film, a silicon nitride film, a silicon oxynitride film, an aluminum oxide film, or the like can be used for the substrate 570 or the like. Stainless steel, aluminum, or the like can be used for the substrate 570 or the like.

For example, a single crystal semiconductor substrate or a polycrystalline semiconductor substrate of silicon or silicon carbide, a compound semiconductor substrate of silicon germanium or the like, or an SOI substrate can be used as the substrate 570 or the like. Thus, a semiconductor element can be provided over the substrate 570 or the like.

For example, an organic material such as a resin, a resin film, or plastic can be used for the substrate 570 or the like. Specifically, a resin film or resin plate of polyester, polyolefin, polyamide, polyimide, polycarbonate, an acrylic resin, or the like can be used for the substrate 570 or the like.

For example, a composite material formed by attaching a metal plate, a thin glass plate, or a film of an inorganic material to a resin film or the like can be used for the substrate 570 or the like. For example, a composite material formed by dispersing a fibrous or particulate metal, glass, inorganic material, or the like into a resin film can be used for the substrate 570 or the like. For example, a composite material formed by dispersing a fibrous or particulate resin, organic material, or the like into an inorganic material can be used for the substrate 570 or the like.

Furthermore, a single-layer material or a layered material in which a plurality of layers are stacked can be used for the substrate 570 or the like. For example, a layered material in which a base, an insulating film that prevents diffusion of impurities contained in the base, and the like are stacked can be used for the substrate 570 or the like. Specifically, a layered material in which glass and one or more of a silicon oxide layer, a silicon nitride layer, a silicon oxynitride layer, and the like that prevent diffusion of impurities contained in the glass are stacked can be used for the substrate 570 or the like. Alternatively, a layered material in which a resin and a film for preventing diffusion of impurities that penetrate the resin, such as a silicon oxide film, a silicon nitride film, and a silicon oxynitride film are stacked can be used for the substrate 570 or the like.

Specifically, a resin film, a resin plate, a layered material, or the like containing polyester, polyolefin, polyamide, polyimide, polycarbonate, an acrylic resin, or the like can be used for the substrate 570 or the like.

Specifically, a material containing polyester, polyolefin, polyamide (e.g., nylon or aramid), polyimide, polycarbonate, polyurethane, an acrylic resin, an epoxy resin, or a resin having a siloxane bond, such as silicone can be used for the substrate 570 or the like.

Specifically, polyethylene terephthalate (PET), polyethylene naphthalate (PEN), polyethersulfone (PES), acrylic, or the like can be used for the substrate 570 or the like. Alternatively, a cyclo olefin polymer (COP), a cyclo olefin copolymer (COC), or the like can be used.

Alternatively, paper, wood, or the like can be used for the substrate 570 or the like.

For example, a flexible substrate can be used as the substrate 570 or the like.

Note that a transistor, a capacitor, or the like can be directly formed on the substrate. Alternatively, a transistor, a capacitor, or the like formed on a substrate for use in manufacturing processes that can resist heat applied in the manufacturing process can be transferred to the substrate 570 or the like. Thus, a transistor, a capacitor, or the like can be formed over a flexible substrate, for example.

### <<Substrate 770>>

For example, a material that can be used for the substrate 570 can be used for the substrate 770. For example, a light-transmitting material that can be used for the substrate 570 can be used for the substrate 770. Alternatively, a material having a surface provided with an antireflective film with a thickness of 1 μm or less can be used for the substrate 770. Specifically, a stack of 3 or more, preferably 5 or more, more preferably 15 or more dielectrics can be used for the substrate 770. This allows visible light reflectivity to be as low as 0.5% or less, preferably 0.08% or less.

Alternatively, a material with low birefringence that can be used for the substrate 570 can be used for the substrate 770.

For example, aluminosilicate glass, tempered glass, chemically tempered glass, sapphire, or the like can be favorably used for the substrate 770 that is on the side closer to a user of the display panel. This can prevent breakage or damage of the display panel caused by the use.

For example, a resin film of a cyclo olefin polymer (COP), a cyclic olefin copolymer (COC), or triacetyl cellulose (TAC) can be favorably used as the substrate 770, in which case the substrate 770 can be lightweight. Alternatively, for example, the display device can be made less likely to suffer from damage by dropping.

A material with a thickness greater than or equal to 0.1 mm and less than or equal to 0.7 mm can be used for the substrate 770, for example. Specifically, a substrate polished to be reduced in the thickness can be used. In that case, the functional film 770D can be close to the first display element 750(i,j). As a result, image blur can be reduced, and an image can be displayed clearly.

### <<Structure Body KB1>>

The structure body KB1 or the like can be formed using an organic material, an inorganic material, or a composite material of an organic material and an inorganic material, for example. Accordingly, a predetermined space can be provided between components between which the structure body KB1 and the like are provided.

Specifically, for the structure body KB1, polyester, polyolefin, polyamide, polyimide, polycarbonate, polysiloxane, an acrylic resin, or the like, or a composite material of a plurality of resins selected from these can be used. Alternatively, a photosensitive material may be used.

### <<Sealing Materials 705 and UF>>

For the sealing material 705, the sealing material UF, or the like, an inorganic material, an organic material, a composite material of an inorganic material and an organic material, or the like can be used.

For example, an organic material such as a thermally fusible resin or a curable resin can be used for the sealing material 705, the sealing material UF, or the like.

For example, an organic material such as a reactive curable adhesive, a light curable adhesive, a thermosetting adhesive, and/or an anaerobic adhesive can be used for the sealing material 705 or the like.

Specifically, an adhesive containing an epoxy resin, an acrylic resin, a silicone resin, a phenol resin, a polyimide resin, an imide resin, a polyvinyl chloride (PVC) resin, a polyvinyl butyral (PVB) resin, or an ethylene vinyl acetate (EVA) resin, or the like can be used for the sealing material 705, the sealing material UF, or the like.

### <<Bonding Layer 505>>

For example, any of the materials that can be used for the sealing material 705 can be used for the bonding layer 505.

### <<Insulating Film 521>>

For example, an insulating inorganic material, an insulating organic material, an insulating composite material containing an inorganic material and an organic material can be used for the insulating film 521 or the like.

Specifically, for example, an inorganic oxide film, an inorganic nitride film, an inorganic oxynitride film, or a material obtained by stacking any of these films can be used as the insulating film 521 or the like. For example, a film including any of a silicon oxide film, a silicon nitride film, a silicon oxynitride film, and an aluminum oxide film, or a film including a material obtained by stacking any of these films can be used as the insulating film 521 or the like.

Specifically, for the insulating film 521 or the like, polyester, polyolefin, polyamide, polyimide, polycarbonate, polysiloxane, an acrylic resin, or the like, or a laminated or composite material of a plurality of kinds of resins selected from these can be used. Alternatively, a photosensitive material may be used.

Thus, steps due to various components overlapping with the insulating film 521 can be reduced, for example.

Furthermore, polyimide having lower moisture permeability than an acrylic resin can be used for the insulating film 521 or the like. In that case, diffusion of impurities into the functional layer 520, the first display element 750(i,j), the second display element 550(i,j), or the like can be inhibited, increasing the reliability of the display panel 700.

### <<Optical Element 560>>

The optical element 560 has an optical axis Z (see FIG. 1C). The optical axis Z passes through the center of the region of the first region 560A to which light is supplied and the center of the third region 560C. The second region 560B includes an inclined portion with an inclination θ of 45° or more, preferably 75° or more and 85° or less, with respect to a plane orthogonal to the optical axis Z. For example, the second region 560B illustrated in FIG. 1C entirely has an inclination of approximately 60° with respect to the plane orthogonal to the optical axis Z.

The region of the first region 560A to which light is supplied has an area larger than 10% of the area of the pixel 702(i,j) (see FIG. 1D).

The third region 560C has an area smaller than or equal to 10% of the area of the pixel 702(i,j).

The reflective film 751B has an area larger than or equal to 70% of the area of the pixel 702(i,j).

The sum of the area of the region of the first region 560A to which light is supplied and the area of the reflective film 751B is larger than the area of the pixel 702(i,j).

For example, a rectangular pixel 27 μm wide and 81 μm long has an area of 2187 μm². In the case of such a pixel, the region of the first region 560A to which light is supplied has an area of 324 μm². The third region 560C has an area of 81 μm², and the reflective film 751B has an area of 1894 μm².

In this structure, the area of a region of the first region 560A to which light is supplied is approximately 14.8% of the area of the pixel.

The area of the reflective film 751B is approximately 86.6% of the area of the pixel.

The sum of the area of the region of the first region 560A to which light is supplied and the area of the reflective film 751B is 2218 μm².

Thus, in the second region, light incident through the first region at various angles can be gathered. Consequently, a novel display panel with high convenience or high reliability can be provided.

Note that a plurality of materials can be used for the optical element 560. For example, a plurality of materials selected such that a difference between their refractive indices is 0.2 or less can be used for the optical element 560. Thus, reflection or scattering of light in the optical element or loss of light can be inhibited.

The optical element 560 can have any of various shapes. For example, the shape of a section orthogonal to the optical axis of the optical element 560 can be a circle or a polygon. The second region 560B of the optical element 560 can have a flat surface or a curved surface.

An example of a cross-sectional view along the optical axis of the optical element 560 having a quadrangle section orthogonal to the optical axis is illustrated in

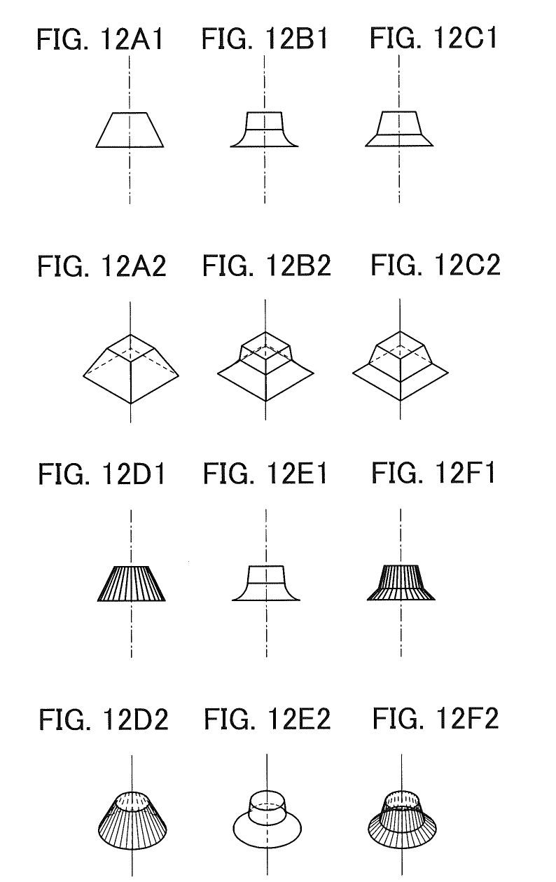

FIG. 12A1, FIG. 12B1, or FIG. 12C1. FIG. 12A2, FIG. 12B2, or FIG. 12C2 shows a perspective view of the optical element 560.

An example of a cross-sectional view along the optical axis of the optical element 560 having a circular section orthogonal to the optical axis is illustrated in FIG. 12D1, FIG. 12E1, or FIG. 12F1. FIG. 12D2, FIG. 12E2, or FIG. 12F2 shows a perspective view of the optical element 560.

### <<Covering Film 565>>

A single-layer film or a laminated film can be used as the covering film 565. For example, a stack of a light-transmitting film and a reflective film can be used for the covering film 565.

For example, an inorganic material such as an oxide film, a fluoride film, or a sulfide film can be used for the light-transmitting film.

For example, metal can be used for the reflective film. Specifically, a material containing silver can be used for the covering film 565. For example, a material containing silver, palladium, and the like or a material containing silver, copper, and the like can be used for the reflective film. Alternatively, a multilayer film of dielectrics can be used for the reflective film.

### <<Insulating Film 528>>

For example, any of the materials that can be used for the insulating film 521 can be used for the insulating film 528 or the like. Specifically, a 1-μm-thick polyimide-containing film can be used as the insulating film 528.

### <<Insulating Film 501B>>

For example, a material that can be used for the insulating film 521 can be used for the insulating film 501B. For example, a material having a function of supplying hydrogen can be used for the insulating film 501B.

Specifically, a material obtained by stacking a material containing silicon and oxygen and a material containing silicon and nitrogen can be used for the insulating film 501B. For example, a material having a function of releasing hydrogen by heating or the like to supply the hydrogen to another component can be used for the insulating film 501B. Specifically, a material having a function of releasing hydrogen taken in the manufacturing process, by heating or the like, to supply the hydrogen to another component can be used for the insulating film 501B.

For example, a film containing silicon and oxygen that is formed by a chemical vapor deposition method using silane or the like as a source gas can be used as the insulating film 501B.

Specifically, a material obtained by stacking a material containing silicon and oxygen and having a thickness greater than or equal to 200 nm and less than or equal to 600 nm and a material containing silicon and nitrogen and having a thickness of approximately 200 nm can be used for the insulating film 501B.

### <<Insulating Film 501C>>

For example, any of the materials that can be used for the insulating film 521 can be used for the insulating film 501C. Specifically, a material containing silicon and oxygen can be used for the insulating film 501C. Thus, diffusion of impurities into the pixel circuit, the second display element, or the like can be inhibited.

For example, a 200-nm-thick film containing silicon, oxygen, and nitrogen can be used as the insulating film 501C.

### <<Wiring, Terminal, and Conductive Film>>

A conductive material can be used for the wiring or the like. Specifically, the conductive material can be used for the signal line S1(j), the signal line S2(j), the scan line G1(i), the scan line G2(i), the wiring CSCOM, the conductive film ANO, the terminal 519B, the terminal 519C, the conductive film 511B, the conductive film 511C, or the like.

For example, an inorganic conductive material, an organic conductive material, a metal, conductive ceramics, or the like can be used for the wiring or the like.

Specifically, a metal element selected from aluminum, gold, platinum, silver, copper, chromium, tantalum, titanium, molybdenum, tungsten, nickel, iron, cobalt, palladium, and manganese can be used for the wiring or the like. Alternatively, an alloy containing any of the above-described metal elements, or the like can be used for the wiring or the like. In particular, an alloy of copper and manganese is suitably used in microfabrication using a wet etching method.

Specifically, any of the following structures can be used for the wiring or the like: a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like.

Specifically, a conductive oxide, such as indium oxide, indium tin oxide, indium zinc oxide, zinc oxide, or zinc oxide to which gallium is added, can be used for the wiring or the like.

Specifically, a film containing graphene or graphite can be used for the wiring or the like.

For example, a film containing graphene oxide is formed and subjected to reduction, whereby a film containing graphene can be formed. As a reducing method, a method with application of heat, a method using a reducing agent, or the like can be employed.

A film containing a metal nanowire can be used for the wiring or the like, for example. Specifically, a nanowire containing silver can be used.

Specifically, a conductive high molecular compound can be used for the wiring or the like.

Note that the terminal 519B can be electrically connected to a flexible printed circuit FPC1 with the use of a conductive material ACF1, for example.

### <<First Conductive Film and Second Conductive Film>>

For example, any of the materials that can be used for the wiring or the like can be used for the first conductive film or the second conductive film.

The electrode 751(i,j), the wiring, or the like can be used for the first conductive film.

The conductive film 512B functioning as the source electrode or the drain electrode of the transistor that can be used for the switch SW1, the wiring, or the like can be used for the second conductive film.

<<First Display Element 750(i,j)>>

For example, a display element having a function of controlling transmission or reflection of light can be used as the first display element 750(i,j). For example, a combined structure of a liquid crystal element and a polarizing plate, a MEMS shutter display element, a MEMS optical coherence display element, or the like can be used. The use of a reflective display element can reduce the power consumption of the display panel. For example, a display element using a microcapsule method, an electrophoretic method, an electrowetting method, or the like can be used as the first display element 750(i,j). Specifically, a reflective liquid crystal display element can be used as the first display element 750(i,j).

For example, a liquid crystal element driven in any of the following driving modes can be used: an in-plane switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, and the like.

Alternatively, a liquid crystal element that can be driven by, for example, a vertical alignment (VA) mode such as a multi-domain vertical alignment (MVA) mode, a patterned vertical alignment (PVA) mode, an electrically controlled birefringence (ECB) mode, a continuous pinwheel alignment (CPA) mode, or an advanced super view (ASV) mode can be used.

The first display element 750(i,j) includes a first electrode, a second electrode, and a layer containing a liquid crystal material. The layer containing a liquid crystal material contains a liquid crystal material whose orientation can be controlled by voltage applied between the first electrode and the second electrode. For example, the orientation of the liquid crystal material can be controlled by an electric field in the thickness direction (also referred to as the vertical direction) or an electric field in the direction that intersects the vertical direction (also referred to as the horizontal direction or the diagonal direction) of the layer containing a liquid crystal material.

### <<Layer 753 Containing Liquid Crystal Material>>

For example, thermotropic liquid crystal, low-molecular liquid crystal, high-molecular liquid crystal, polymer dispersed liquid crystal, ferroelectric liquid crystal, anti-ferroelectric liquid crystal, or the like can be used for the layer containing a liquid crystal material. Alternatively, a liquid crystal material which exhibits a cholesteric phase, a smectic phase, a cubic phase, a chiral nematic phase, an isotropic phase, or the like can be used. Alternatively, a liquid crystal material which exhibits a blue phase can be used.

For example, a negative liquid crystal material can be used for the layer containing a liquid crystal material.

For example, a liquid crystal material having a resistivity of greater than or equal to 1.0×10¹³ Ω·cm, preferably greater than or equal to 1.0×10¹⁴ Ω·cm, more preferably greater than or equal to 1.0×10¹⁵ Ω·cm, is used for the layer 753 containing a liquid crystal material. This can suppress a variation in the transmittance of the first display element 750(i,j). Alternatively, flickering of the first display element 750(i,j) can be suppressed. Alternatively, the rewriting frequency of the first display element 750(i,j) can be reduced.

<<Electrode 751(i,j)>>

For example, the material that is used for the wiring or the like can be used for the electrode 751(i,j). Specifically, a reflective film can be used for the electrode 751(i,j). For example, a material in which a light-transmitting conductive film and a reflective film having an opening are stacked can be used for the electrode 751(i,j).

### <<Reflective Film>>

For example, a material that reflects visible light can be used for the reflective film. Specifically, a material containing silver can be used for the reflective film. For example, a material containing silver, palladium, and the like or a material containing silver, copper, and the like can be used for the reflective film.

The reflective film reflects light that passes through the layer 753 containing a liquid crystal material, for example. This allows the first display element 750 to serve as a reflective liquid crystal element. Alternatively, for example, a material with unevenness on its surface can be used for the reflective film. In that case, incident light can be reflected in various directions so that a white image can be displayed.

For example, the first conductive film, the electrode 751(i,j), or the like can be used as the reflective film.

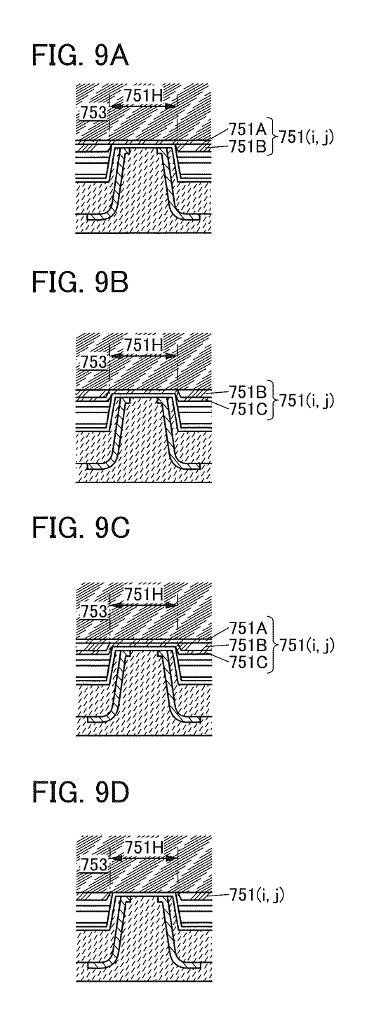

For example, a film including a region positioned such that a light-transmitting conductive film 751A is sandwiched between the region and the layer 753 containing a liquid crystal material can be used as the reflective film 751B (see FIG. 9A).

For example, a film including a region positioned between the layer 753 containing a liquid crystal material and a light-transmitting conductive film 751C can be used as the reflective film 751B (see FIG. 9B).

For example, a film including a region positioned between the light-transmitting conductive film 751A and the light-transmitting conductive film 751C can be used as the reflective film 751B (see FIG. 9C).

For example, a film reflecting visible light may be used for the electrode 751(i,j) (see FIG. 9D).

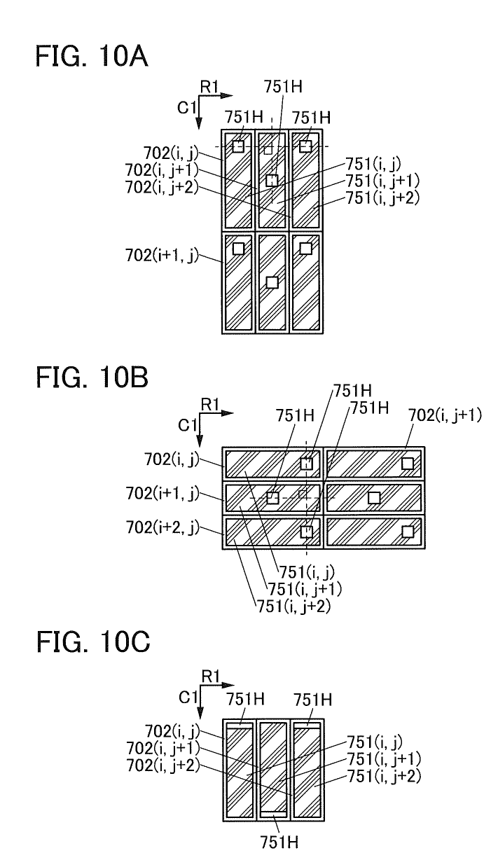

The reflective film has a shape including the region 751H where light emitted from the second display element 550(i,j) is not blocked (see FIGS. 10A to 10C).

For example, the reflective film can have one or more openings. Specifically, the region 751H may have a polygonal shape, a quadrangular shape, an elliptical shape, a circular shape, a cross-like shape, or the like. The region 751H may alternatively have a stripe shape, a slit-like shape, or a checkered pattern.

If the ratio of the total area of the region 751H to the total area of the reflective film is too large, an image displayed using the first display element 750(i,j) is dark.

If the ratio of the total area of the region 751H to the total area of the reflective film is too small, an image displayed using the second display element 550(i,j) is dark. The reliability of the second display element 550(i,j) may be degraded.

For example, the region 751H provided in the pixel 702(i,j+1) is not provided on a line that extends in the row direction (the direction indicated by the arrow R1 in the drawing) through the region 751H provided in the pixel 702(i,j) (see FIG. 10A). Alternatively, for example, the region 751H provided in the pixel 702(i+1,j) is not provided on a line that extends in the column direction (the direction indicated by the arrow C1 in the drawing) through the region 751H provided in the pixel 702(i,j) (see FIG. 10B).

For example, the region 751H provided in the pixel 702(i,j+2) is provided on a line that extends in the row direction through the region 751H provided in the pixel 702(i,j) (see FIG. 10A). In addition, the region 751H provided in the pixel 702(i,j+1) is provided on a line that is perpendicular to the above line between the region 751H provided in the pixel 702(i,j) and the region 751H provided in the pixel 702(i,j+2).

Alternatively, for example, the region 751H provided in the pixel 702(i+2,j) is provided on a line that extends in the column direction through the region 751H provided in the pixel 702(i,j) (see FIG. 10B). In addition, for example, the region 751H provided in the pixel 702(i+1,j) is provided on a line that is perpendicular to the above line between the region 751H provided in the pixel 702(i,j) and the region 751H provided in the pixel 702(i+2,j).

When the second display elements are provided in the above manner to overlap with the regions where light is not blocked, the second display element of one pixel adjacent to another pixel can be apart from a second display element of the another pixel. A display element that displays color different from that displayed from the second display element of one pixel can be provided as the second display element of another pixel adjacent to the one pixel. The difficulty in arranging a plurality of display elements that represent different colors adjacent to each other can be lowered. Thus, a novel display panel with high convenience or high reliability can be provided.

The reflective film can have a shape in which an end portion is cut off so as to form the region 751H, for example (see FIG. 10C). Specifically, the electrode 751(i,j) whose end portion is cut off so as to be shorter in the column direction (the direction indicated by an arrow C1 in the drawing) can be used.

### <<Electrode 752>>

For example, a material that can be used for the wiring or the like can be used for the electrode 752. For example, a material that has a light-transmitting property selected from materials that can be used for the wiring or the like can be used for the electrode 752.

For example, a conductive oxide, a metal film thin enough to transmit light, a metal nanowire, or the like can be used for the electrode 752.

Specifically, a conductive oxide containing indium can be used for the electrode 752. Alternatively, a metal thin film with a thickness greater than or equal to 1 nm and less than or equal to 10 mn can be used for the electrode 752. Alternatively, a metal nanowire containing silver can be used for the electrode 752.

Specifically, indium oxide, indium tin oxide, indium zinc oxide, zinc oxide, zinc oxide to which gallium is added, zinc oxide to which aluminum is added, or the like can be used for the electrode 752.

### <<Alignment Films AF1 and AF2>>

The alignment films AF1 and AF2 can be formed using a material containing polyimide or the like, for example. Specifically, a material formed by rubbing treatment or an optical alignment technique such that a liquid crystal material has predetermined alignment can be used.

For example, a film containing soluble polyimide can be used for the alignment film AF1 or AF2. In that case, the temperature required in forming the alignment film AF1 or AF2 can be low. As a result, damage to other components caused when the alignment film AF1 or the alignment film AF2 is formed can be reduced.

### <<Coloring Film CF1>>

The coloring film CF1 can be formed using a material transmitting light of a certain color and can thus be used for a color filter or the like.

For example, a material that transmits blue light, green light, or red light can be used for the coloring film CF1. In that case, the spectral width of light that is transmitted through the coloring film CF1 can be narrowed, so that clear display can be provided.

Furthermore, for example, a material that absorbs blue light, green light, or red light can be used for the coloring film CF1. Specifically, a material transmitting yellow light, magenta light, or cyan light can be used for the coloring film CF1. In that case, the spectral width of light that is absorbed by the coloring film CF1 can be narrowed, so that bright display can be provided.

### <<Light-Blocking Film BM>>

The light-blocking film BM can be formed with a material that prevents light transmission and can thus be used as a black matrix, for example.

Specifically, a resin containing a pigment or dye can be used for the light-blocking film BM. For example, a resin in which carbon black is dispersed can be used for the blocking film.

Alternatively, an inorganic compound, an inorganic oxide, a composite oxide containing a solid solution of a plurality of inorganic compounds, or the like can be used for the light-blocking film BM. Specifically, a black chromium film, a film containing cupric oxide, or a film containing copper chloride or tellurium chloride can be used for the light-blocking film BM.

### <<Insulating Film 771>>

The insulating film 771 can be formed of polyimide, an epoxy resin, an acrylic resin, or the like.

### <<Functional Films 770P and 770D>>

An antireflective film, a polarizing film, a retardation film, a light diffusion film, a condensing film, or the like can be used for the functional film 770P or the functional film 770D, for example.

Specifically, a film containing a dichromatic pigment can be used for the functional film 770P or the functional film 770D. Alternatively, a material with a columnar structure having an axis along the direction intersecting a surface of a base can be used for the functional film 770P or the functional film 770D. In that case, light can be easily transmitted in the direction along the axis and easily scattered in other directions.

Alternatively, an antistatic film preventing the attachment of a foreign substance, a water repellent film suppressing the attachment of stain, a hard coat film suppressing a scratch in use, or the like can be used as the functional film 770P.

Specifically, a circularly polarizing film can be used for the functional film 770P. Furthermore, a light diffusion film can be used for the functional film 770D.

<<Second Display Element 550(i,j)>>

For example, a display element having a function of emitting light can be used as the second display element 550(i,j). Specifically, a light-emitting diode or the like can be used as the second display element 550(i,j). For example, a micro LED can be used as the second display element 550(i,j). Specifically, a micro LED whose light-emitting region has an area of 1 mm² or less, preferably 10000 μm² or less, more preferably 3000 μm² or less, still more preferably 700 μm² or less can be used as the second display element 550(i,j).

The second display element 550(i,j) includes the electrode 551(i,j), the electrode 552, and the multilayer film 553. The multilayer film 553 includes a semiconductor film. The multilayer film 553 includes, for example, a p-type clad layer, an n-type clad layer, and a light-emitting layer that includes a region positioned between the p-type clad layer and the n-type clad layer. For example, the electrode 551(i,j) and the electrode 552 are electrically connected to the p-type clad layer and the n-type clad layer, respectively. This allows recombination of carriers in the light-emitting layer, resulting in light emission.

For example, a laminated material for emitting blue light, green light, or red light can be used for the multilayer film 553. Specifically, a compound of gallium and phosphorus, a compound of gallium and arsenic, a compound of gallium, aluminum, and arsenic, a compound of aluminum, gallium, indium, and phosphorus, a compound of indium and gallium nitride, or the like can be used for the multilayer film 553.

For example, any of the materials that can be used for the wiring or the like can be used for the electrode 551(i,j) or the electrode 552. Alternatively, a material that transmits light emitted from the multilayer film 553 and is selected from the materials that can be used for the wiring or the like can be used for the electrode 551(i,j).

For example, conductive oxide, indium-containing conductive oxide, indium oxide, indium tin oxide, indium zinc oxide, zinc oxide, zinc oxide to which gallium is added, or the like can be used for the electrode 551(i,j). Alternatively, a metal film that is thin enough to transmit light can be used for the electrode 551(i,j).

### <<Color Conversion Layer CC>>

A color conversion layer CC can be used. The color conversion layer CC has a function of absorbing light of a color that is emitted from the second display element 550(i,j) and emitting light of a different color.

The color conversion layer CC has a function of absorbing blue light emitted from the second display element 550(i,j) and emitting yellow light, for example. Thus, yellow light emitted from the color conversion layer CC and blue light transmitted through the color conversion layer CC can be mixed, so that white light can be obtained.

The color conversion layer CC has a function of absorbing near-ultraviolet light emitted from the second display element 550(i,j) and emitting red light, green light, and blue light, for example. Thus, a light-emitting element that emits near-ultraviolet light can be used as the second display element 550(i,j). Accordingly, near-ultraviolet light can be converted to white light or light having an excellent color rendering property.

For example, a phosphor can be used for the color conversion layer. Alternatively, a quantum dot can be used for the color conversion layer. The use of a quantum dot for the color conversion layer allows emission of vivid-color light with a narrow half width.

### <<Conductive Materials 31 and 32>>

For example, a conductive paste, indium-containing solder, or an anisotropic conductive film can be used for the conductive material 31 or the conductive material 32.

### <<Driver Circuit GD>>

Any of a variety of sequential circuits, such as a shift register, can be used as the driver circuit GD. For example, a transistor MD, a capacitor, and the like can be used in the driver circuit GD. Specifically, a transistor including a semiconductor film that can be formed in the same process as the semiconductor film of the transistor M or the transistor that can be used as the switch SW1 can be used.

As the transistor MD, a transistor having a structure different from that of the transistor that can be used as the switch SW1 can be used, for example. Specifically, a transistor including the conductive film 524 can be used as the transistor MD (see FIG. 5B).

Note that the transistor MD can have the same structure as the transistor M.

### <<Transistor>>

For example, semiconductor films formed in the same process can be used for transistors in the driver circuit and the pixel circuit.

As the transistor in the driver circuit or the pixel circuit, a bottom-gate transistor or a top-gate transistor can be used, for example.

A manufacturing line for a bottom-gate transistor including amorphous silicon as a semiconductor can be easily remodeled into a manufacturing line for a bottom-gate transistor including an oxide semiconductor as a semiconductor, for example. Furthermore, for example, a manufacturing line for a top-gate transistor including polysilicon as a semiconductor can be easily remodeled into a manufacturing line for a top-gate transistor including an oxide semiconductor as a semiconductor. In either reconstruction, a conventional manufacturing line can be effectively used.

For example, a transistor including a semiconductor containing an element belonging to Group 14 for a semiconductor film can be used. Specifically, a semiconductor containing silicon can be used for a semiconductor film. For example, single crystal silicon, polysilicon, microcrystalline silicon, or amorphous silicon can be used for the semiconductor film of the transistor.

Note that the temperature for forming a transistor using polysilicon as a semiconductor is lower than the temperature for forming a transistor using single crystal silicon as a semiconductor.

In addition, the transistor using polysilicon as a semiconductor has higher field-effect mobility than the transistor using amorphous silicon as a semiconductor, and therefore a pixel including the transistor using polysilicon can have a high aperture ratio. Moreover, pixels arranged at high resolution, a gate driver circuit, and a source driver circuit can be formed over the same substrate. As a result, the number of components included in an electronic device can be reduced.

In addition, the transistor using polysilicon as a semiconductor has higher reliability than the transistor using amorphous silicon as a semiconductor.

Alternatively, a transistor including a compound semiconductor can be used. Specifically, a semiconductor containing gallium arsenide can be used for a semiconductor film.

Alternatively, a transistor including an organic semiconductor can be used. Specifically, an organic semiconductor containing any of polyacenes and graphene can be used for a semiconductor film.

For example, a transistor using an oxide semiconductor for a semiconductor film can be used. Specifically, an oxide semiconductor containing indium or an oxide semiconductor containing indium, gallium, and zinc can be used for a semiconductor film.

For example, a transistor having a lower leakage current in an off state than a transistor using amorphous silicon for a semiconductor film can be used. Specifically, a transistor using an oxide semiconductor for a semiconductor film can be used.

Thus, a pixel circuit can hold an image signal for a longer time than a pixel circuit including a transistor that uses amorphous silicon for a semiconductor film. Specifically, the selection signal can be supplied at a frequency of lower than 30 Hz, preferably lower than 1 Hz, more preferably less than once per minute while flickering is suppressed. Consequently, eyestrain on a user of the data processing device can be reduced, and power consumption for driving can be reduced.

For example, a transistor including a semiconductor film 508, a conductive film 504, the conductive film 512A, and the conductive film 512B can be used as the switch SW1 (see FIG. 6B). The insulating film 506 includes a region positioned between the semiconductor film 508 and the conductive film 504.

The conductive film 504 includes a region overlapping with the semiconductor film 508. The conductive film 504 functions as a gate electrode. The insulating film 506 functions as a gate insulating film.

The conductive films 512A and 512B are electrically connected to the semiconductor film 508. The conductive film 512A has one of a function of a source electrode and a function of a drain electrode, and the conductive film 512B has the other.

Furthermore, a transistor including the conductive film 524 can be used as the transistor included in the driver circuit or the pixel circuit (see FIG. 5B). The conductive film 524 includes a region provided such that the semiconductor film 508 is positioned between the conductive film 504 and the conductive film 524. The insulating film 516 includes a region positioned between the conductive film 524 and the semiconductor film 508. For example, the conductive film 524 can be electrically connected to a wiring that supplies the same potential as that supplied to the conductive film 504.

A conductive film in which a 10-nm-thick film containing tantalum and nitrogen and a 300-nm-thick film containing copper are stacked can be used as the conductive film 504, for example. A film containing copper includes a region provided such that a film containing tantalum and nitrogen is positioned between the film containing copper and the insulating film 506.

A material in which a 400-nm-thick film containing silicon and nitrogen and a 200-nm-thick film containing silicon, oxygen, and nitrogen are stacked can be used for the insulating film 506, for example. Note that the film containing silicon and nitrogen includes a region provided such that the film containing silicon, oxygen, and nitrogen is positioned between the film containing silicon and nitrogen and the semiconductor film 508.

For example, a 25-nm-thick film containing indium, gallium, and zinc can be used as the semiconductor film 508.

For example, a conductive film in which a 50-nm-thick film containing tungsten, a 400-nm-thick film containing aluminum, and a 100-nm-thick film containing titanium are stacked in this order can be used as the conductive film 512A or 512B. Note that the film containing tungsten includes a region in contact with the semiconductor film 508.

### <Structural Example 6 of Display Panel>

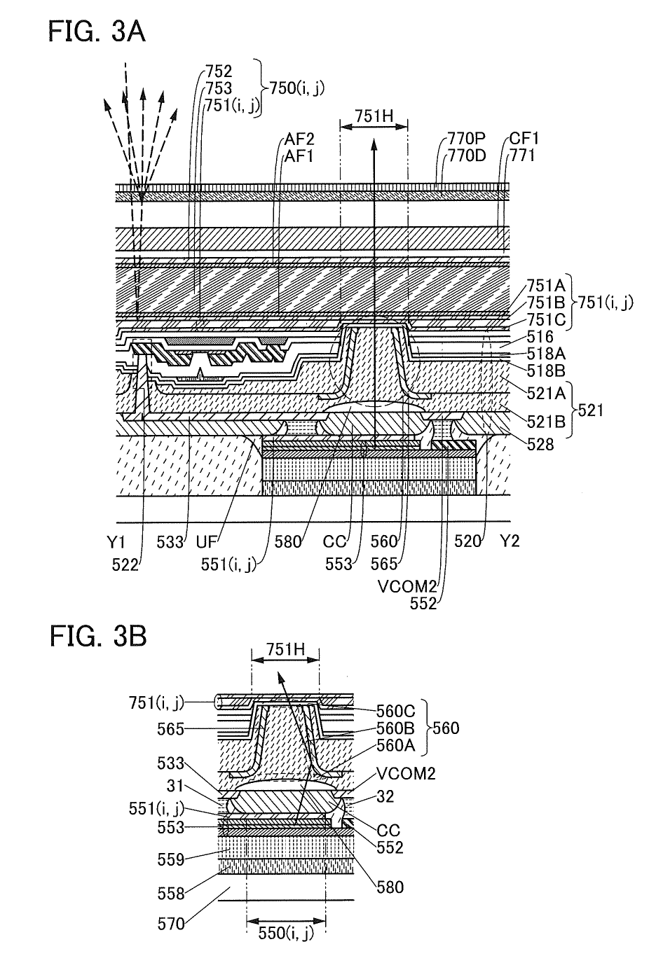

The structure of a display panel of one embodiment of the present invention will be described with reference to FIGS. 3A and 3B.

FIGS. 3A and 3B illustrate the structure of the display panel of one embodiment of the present invention. FIG. 3A is a cross-sectional view of a pixel, which corresponds to the cross-sectional view taken along line Y1-Y2 in FIG. 1A. FIG. 3B is a cross-sectional view illustrating part of FIG. 3A.

The structure of the display panel described in this structural example is the same as that of the display panel 700 described with reference to FIGS. 2A and 2B except that a lens 580 is provided. Different portions will be described in detail below, and the above description is referred to for the similar portions.

The display panel described in this embodiment includes the lens 580. The lens 580 includes a region positioned between the optical element 560 and the second display element 550(i,j) (see FIGS. 3A and 3B).

The lens 580 is a convex lens that includes a material with a refractive index of 1.5 or more and 2.5 or less.

With such a structure, light emitted from the second display element can be gathered toward the optical axis of the optical element, for example. Alternatively, light emitted from the second display element can be used efficiently. Alternatively, the density of a current supplied to the light-emitting diode can be decreased. Alternatively, the area of the second display element can be increased. Alternatively, the reliability of the light-emitting diode can be increased. Consequently, a novel display panel with high convenience or high reliability can be provided.

For example, a plano-convex lens can be used as the lens 580.

### <<Lens 580>>

A plano-convex lens or a double-convex lens can be used as the lens 580.

A material that transmits visible light can be used for the lens 580. Alternatively, a material whose refractive index is greater than or equal to 1.3 and less than or equal to 2.5 can be used for the lens 580. For example, an inorganic material or an organic material can be used for the lens 580.

For example, a material including an oxide or a sulfide can be used for the lens 580.

Specifically, cerium oxide, hafnium oxide, lanthanum oxide, magnesium oxide, niobium oxide, tantalum oxide, titanium oxide, yttrium oxide, zinc oxide, an oxide containing indium and tin, an oxide containing indium, gallium, and zinc, or the like can be used for the lens 580. Alternatively, zinc sulfide or the like can be used for the lens 580.

For example, the lens 580 can be formed using a material containing a resin. Specifically, the lens 580 can be formed using a resin to which chlorine, bromine, or iodine is introduced, a resin to which a heavy metal atom is introduced, a resin to which an aromatic ring is introduced, a resin to which sulfur is introduced, or the like. Alternatively, the lens 580 can be formed using a material containing a resin and nanoparticles of a material whose refractive index is higher than that of the resin. Titanium oxide, zirconium oxide, or the like can be used for the nanoparticles.

Note that this embodiment can be combined with any of the other embodiments in this specification as appropriate.

### Embodiment 2

In this embodiment, the structures of display devices of embodiments of the present invention will be described with reference to FIGS. 13A and 13B and FIGS. 14A to 14B3.

FIG. 13A is a block diagram illustrating the structure of the display device of one embodiment of the present invention. FIG. 13B is a block diagram illustrating the structure of a pixel illustrated in FIG. 13A.

FIG. 14A is a block diagram illustrating a structure different from the structure of the display panel illustrated in FIG. 13A. FIGS. 14B1 to 14B3 are external views of display devices of embodiments of the present invention.

### <Structural Example of Display Device>

The display device described in this embodiment includes a control portion 238 and the display panel 700 (see FIG. 13A).

### <<Control Portion 238>>

The control portion 238 has a function of receiving image data V1 and control data SS.

The control portion 238 has a function of generating the data V11 and the data V12 on the basis of the image data V1 and a function of supplying the data V11 and the data V12.

For example, the control portion 238 includes a decompression circuit 234 and an image processing circuit 235M.

### <<Display Panel 700>>

The display panel 700 has a function of receiving the data V11 and the data V12. The display panel 700 includes the pixel 702(i,j).

The pixel 702(i,j) includes the first display element 750(i,j) and the second display element 550(i,j) (see FIG. 13B).

The first display element 750(i,j) has a function of performing display on the basis of the data V11. The first display element 750(i,j) is a reflective display element.

The second display element 550(i,j) has a function of performing display on the basis of the data V12. The second display element 550(i,j) is a light-emitting element.

For example, any of the display panels described in Embodiment 1 can be used as the display panel 700. Alternatively, the display panel 700B can be used. For example, a television receiver system (see FIG. 14B1), a video monitor (see FIG. 14B2), a laptop computer (see FIG. 14B3), or the like can be provided.

Thus, image data can be displayed by controlling the intensity of light reflected by the reflective film with the use of the first display element. Alternatively, the first display element can use external light to display an image. Alternatively, glare of external light can be hardly perceived. Furthermore, image data can be displayed using the second display element. Furthermore, image data can be displayed using the second display element such that the image data overlaps with the image data displayed using the first display element. Furthermore, the image data displayed using the first display element can be complemented using the second display element. Consequently, a novel display device with high convenience or high reliability can be provided.

Hybrid display is a method for displaying text or an image with the use of reflected light and self-emitted light together in one panel that complement the color tone or light intensity of each other. Alternatively, hybrid display is a method for displaying text and/or an image with the use of light from a plurality of display elements in one pixel or one subpixel. Note that when a hybrid display that performs hybrid display is locally observed, a pixel or a subpixel that performs display using any one of the plurality of display elements and a pixel or a subpixel that performs display using two or more of the plurality of display elements are included in some cases.

Note that in the present specification and the like, hybrid display satisfies any one or a plurality of the above descriptions.

Furthermore, a hybrid display includes a plurality of display elements in one pixel or one subpixel. Note that as an example of the plurality of display elements, a reflective element that reflects light and a self-luminous element that emits light can be given. Note that the reflective element and the self-luminous element can be controlled independently. A hybrid display has a function of displaying text and/or an image with the use of one or both of reflected light and self-emitted light in a display portion.

### <<Decompression Circuit 234>>

The decompression circuit 234 has a function of decompressing the image data V1 supplied in a compressed state. The decompression circuit 234 includes a memory portion. The memory portion has a function of storing decompressed image data, for example (see FIG. 13A).

<<Image processing Circuit 235M>>

The image processing circuit 235M includes a region 235M(1) and a region 235M(2), for example.

The region 235M(1) or the region 235M(2) has a function of storing data contained in the image data V1, for example.

The image processing circuit 235M has a function of generating the data V11 by correcting the image data V1 on the basis of a predetermined characteristic curve and a function of supplying the data V11, for example. Specifically, the image processing circuit 235M has a function of generating the data V11 so that the first display element displays a favorable image.

The image processing circuit 235M has a function of generating the data V12 by correcting the image data V1 on the basis of a predetermined characteristic curve and a function of supplying the data V12, for example. Specifically, the image processing circuit 235M has a function of generating the data V12 so that the second display element displays a favorable image.

Note that this embodiment can be combined with any of the other embodiments in this specification as appropriate.

### Embodiment 3

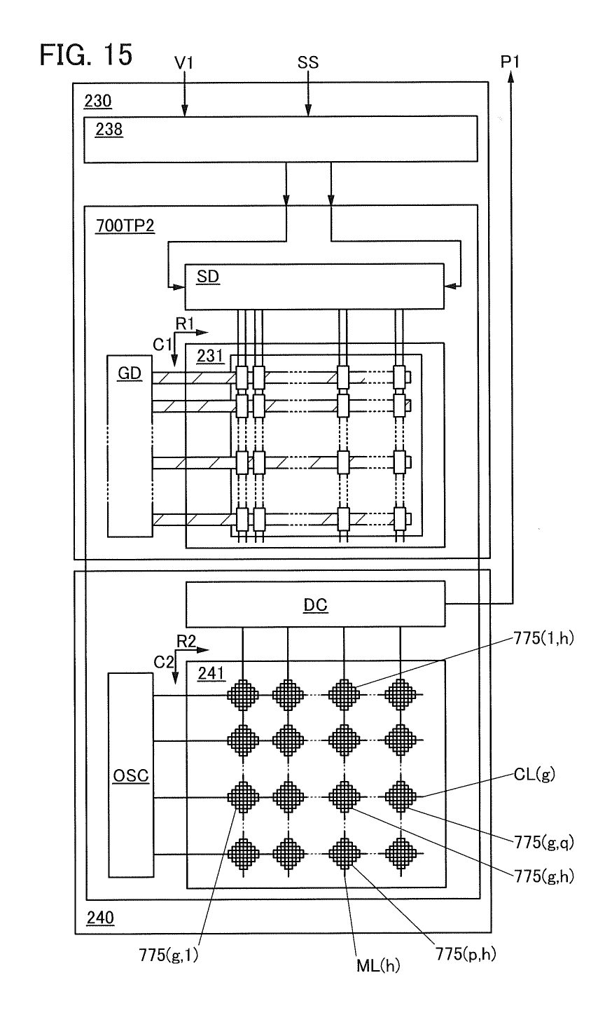

In this embodiment, the structure of an input/output device of one embodiment of the present invention will be described with reference to FIG. 15.

FIG. 15 is a block diagram illustrating the structure of the input/output device of one embodiment of the present invention.

### <Structural Example of Input/Output Device>

The input/output device described in this embodiment includes a display portion 230 and an input portion 240 (see FIG. 15). For example, the display panel 700 described in Embodiment 1 can be used for the display portion 230.

The input portion 240 includes a sensing region 241 and has a function of sensing an object that approaches the sensing region 241.

The sensing region 241 includes a region overlapping with the pixel 702(i,j).

### <<Input Portion 240>>

The input portion 240 includes a sensing region 241 and can include an oscillator circuit OSC and a detection circuit DC (see FIG. 15).

The sensing region 241 can include a sensor element, for example.

### <<Sensor Element>>

A sensor element has a function of sensing an approaching pointer. For example, a finger, a stylus pen, or the like can be used as the pointer. Specifically, a piece of metal, a coil, or the like can be used for the stylus pen.

For example, a capacitive proximity sensor, an electromagnetic inductive proximity sensor, an optical proximity sensor, a resistive proximity sensor, or the like can be used as the sensor element.

Alternatively, a plurality of kinds of proximity sensors can be used in combination. For example, a proximity sensor that senses a finger and a proximity sensor that senses a stylus pen can be used in combination. This allows determination of the kind of a pointer. Alternatively, an instruction can be associated with sensing data depending on the kind of a pointer. Specifically, in the case where it is determined that a finger is used as a pointer, sensing data can be associated with a gesture. In the case where it is determined that a stylus pen is used as a pointer, sensing data can be associated with drawing processing.

Specifically, a capacitive proximity sensor or an optical proximity sensor can be used to sense a finger. Alternatively, an electromagnetic inductive proximity sensor or an optical proximity sensor can be used to sense a stylus pen.

Note that this embodiment can be combined with any of the other embodiments in this specification as appropriate.

### Embodiment 4

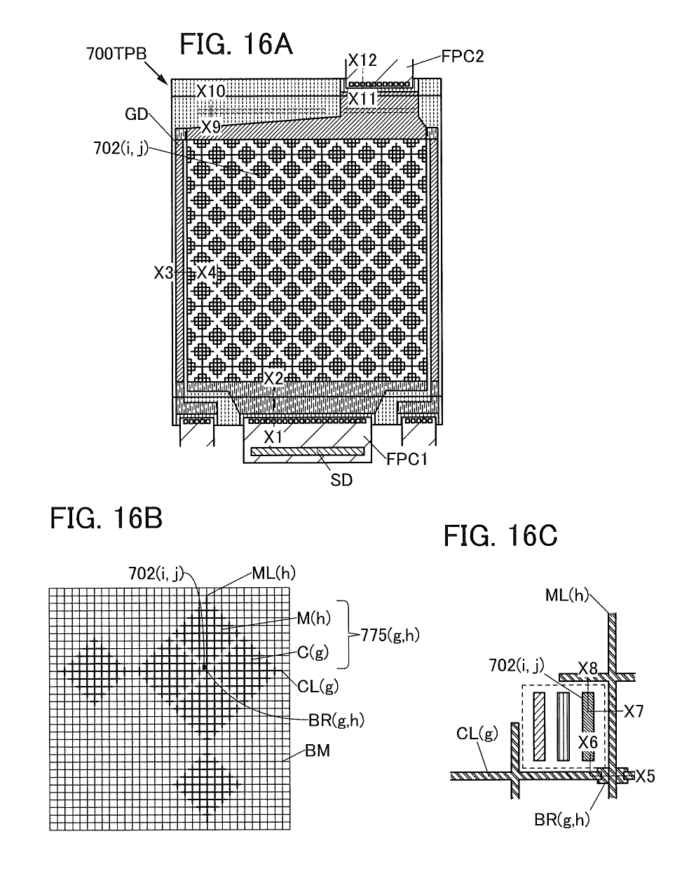

In this embodiment, the structure of an input/output panel of one embodiment of the present invention will be described with reference to FIGS. 16A to 16C to FIG. 18.

FIGS. 16A to 16C illustrate the structure of the input/output panel that can be used for the input/output device of one embodiment of the present invention. FIG. 16A is a top view of the input/output panel. FIG. 16B is a schematic view illustrating part of an input portion of the input/output panel, and FIG. 16C is a schematic view illustrating part of FIG. 16B.

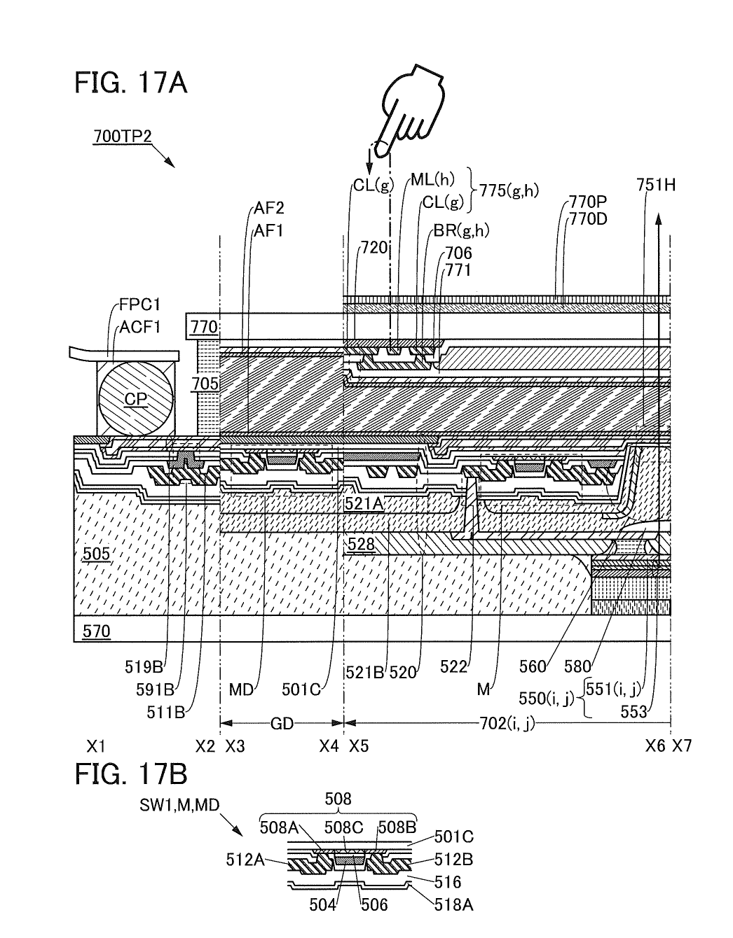

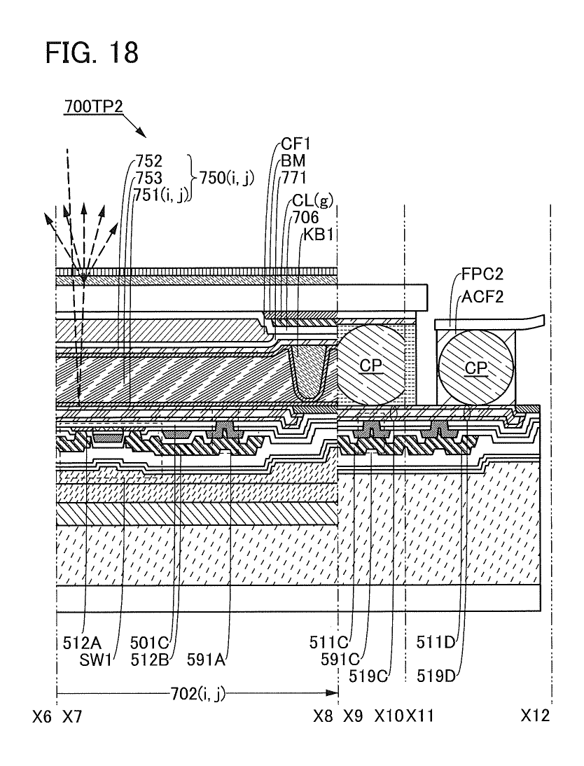

FIGS. 17A and 17B and FIG. 18 illustrate the structure of the input/output panel which can be used for the input/output device of one embodiment of the present invention. FIG. 17A is a cross-sectional view taken along lines X1-X2 and X3-X4 in FIG. 16A and line X5-X6 in FIG. 16C. FIG. 17B is a cross-sectional view illustrating part of the structure illustrated in FIG. 17A.

FIG. 18 is a cross-sectional view taken along line X7-X8 in FIG. 16C and lines X9-X10 and X11-X12 in FIG. 16A.

### <Structural Example 1 of Input/Output Panel>

The input/output panel 700TP2 described in this embodiment is different from the display panel 700 described in Embodiment 1, for example, in that the functional layer 720 has a different structure and a top-gate transistor is provided. Different portions will be described in detail below, and the above description is referred to for the similar portions.

### <<Functional Layer 720>>

The functional layer 720 includes a region positioned between the substrate 770 and the insulating film 501C. The functional layer 720 includes the light-blocking film BM, the insulating film 771, the coloring film CF1, a control line CL(g), a sensor signal line ML(h), and a sensor element 775(g,h) (see FIG. 17A).

Note that a gap between the control line CL(g) and the electrode 752 or between the sensor signal line ML(h) and the electrode 752 is greater than or equal to 0.2 μm and less than or equal to 16 μm, preferably greater than or equal to 1 μm and less than or equal to 8 μm, more preferably greater than or equal to 2.5 μm and less than or equal to 4 μm. This can reduce an influence of a control signal or a sensor signal on the display state of the first display element. Furthermore, the input/output panel can be made thin.

### <<Sensing Region 241>>

The sensing region 241 includes part of the functional layer 720. For example, the sensing region 241 includes the control line CL(g), the sensor signal line ML(h), and the sensor element 775(g,h).

The sensor element 775(g,h) is electrically connected to the control line CL(g) and the sensor signal line ML(h).

The control line CL(g) has a function of supplying a control signal. The sensor signal line ML(h) has a function of receiving a sensor signal.

<<Sensor Element 775(g,h)>>

The sensor element 775(g,h) has a function of supplying a sensor signal that varies in accordance with a control signal and a distance between a region overlapping with the pixel 702(i,j) and an object approaching the region. The sensor element 775(g,h) includes a first electrode C(g) and a second electrode M(h).

The first electrode C(g) includes a light-transmitting region in the region overlapping with the pixel 702(i,j) and is electrically connected to the control line CL(g).

The second electrode M(h) includes a light-transmitting region in the region overlapping with the pixel 702(i,j) and is electrically connected to the sensor signal line ML(h). The second electrode M(h) is located such that an electric field part of which is blocked by an object approaching the region overlapping with the pixel 702(i,j) is generated between the second electrode M(h) and the first electrode C(g).

With such a structure, an object approaching the region overlapping with the display portion can be sensed while image data is displayed by the display portion. Alternatively, a finger or the like that approaches the display portion can be used as a pointer to input positional data. Alternatively, positional data can be associated with image data displayed on the display portion. Consequently, a novel input/output device with high convenience or high reliability can be provided.

### <<Oscillation Circuit OSC>>

The oscillator circuit OSC is electrically connected to the control line CL(g) and has a function of supplying a control signal. For example, a rectangular wave, a sawtooth wave, a triangular wave, or the like can be used as the control signal.

### <<Detection Circuit DC>>

The detection circuit DC is electrically connected to the sensor signal line ML(h) and has a function of supplying a sensor signal in response to a change in the potential of the sensor signal line ML(h). Note that the sensor signal includes positional data P1, for example.

### <<Display Portion 230>>

Any of the display panels described in Embodiment 1 can be used for the display portion 230, for example. Alternatively, the display device described in Embodiment 2 can be used for the display portion 230.

Note that part of light emitted from the second display element 550(i,j) passes through the layer 753 containing a liquid crystal material and then is reflected by the control line CL(g), the electrode 752, or the like in some cases. Reflection is repeated between the electrode 752 and the electrode 751(i,j) in some cases, for example. Alternatively, reflection is repeated between the substrate 770 and the electrode 751(i,j) in some cases. Thus, image data can be displayed like indirect lighting with light emitted from the second display element. Alternatively, the second display element can display an image which gives less stress on eyes.

<<Sensor Element 775(g,h)>>

The sensor element 775(g,h) includes the first electrode C(g) and the sensor signal line ML(h).

For example, a light-transmitting conductive film can be used for the first electrode C(g) and the sensor signal line ML(h). Alternatively, a conductive film having an opening at a region overlapping with the pixel 702(i,j) can be used for the first electrode C(g) and the sensor signal line ML(h). Accordingly, an object that approaches the region overlapping with the display panel can be sensed without disturbing display of the display panel.

Alternatively, a metal film having higher conductivity than a transparent conductive film can be used for the first electrode C(g) and the sensor signal line ML(h). Thus, the thickness of the input/output device can be reduced.

Note that the light-blocking film BM can be used (see FIG. 16B and FIG. 18). The light-blocking film BM includes a region overlapping with the first electrode C(g) and the sensor signal line ML(h) and a region positioned between the substrate 770 and the first electrode C(g) or between the substrate 770 and the sensor signal line ML(h), for example. Thus, the intensity of external light reflected by the sensor element 775(g,h) can be reduced. Consequently, a novel input/output device with high convenience or high reliability can be provided.

The sensing region 241 includes a group consisting of sensor elements 775(g,1) to 775(g,q) and another group consisting of sensor elements 775(1,h) to 775(p,h) (see FIG. 15). Note that g is an integer greater than or equal to 1 and less than or equal top, h is an integer greater than or equal to 1 and less than or equal to q, and each of p and q is an integer greater than or equal to 1.

The one group of sensor elements 775(g,1) to 775(g,q) include the sensor element 775(g,h) and are arranged in the row direction (indicated by the arrow R2 in the drawing). Note that the direction indicated by the arrow R2 in FIG. 15 may be the same as or different from the direction indicated by the arrow R1 in FIG. 15.

The another group of sensor elements 775(1,h) to 775(p,h) include the sensor element 775(g,h) and are provided in the column direction (indicated by the arrow C2 in FIG. 15) that intersects the row direction.

The one group of sensor elements 775(g,1) to 775(g,q) provided in the row direction include the first electrode C(g) that is electrically connected to the control line CL(g) (see FIG. 16B). For example, a conductive film that can be formed in the same step can be used for the control line CL(g) and the first electrode C(g).

The another group of sensor elements 775(1,h) to 775(p,h) provided in the column direction include the electrode M(h) electrically connected to the sensor signal line ML(h). For example, a conductive film that can be formed in the same step can be used for a control line ML(h) and the electrode M(h).

The control line CL(g) includes a conductive film BR(g,h) (see FIGS. 16B and 16C and FIG. 17A). The conductive film BR(g,h) includes a region overlapping with the sensor signal line ML(h).

An insulating film 706 includes a region positioned between the sensor signal line ML(h) and the conductive film BR(g,h). Thus, a short circuit between the sensor signal line ML(h) and the conductive film BR(g,h) can be prevented.

### <<Conductive Film 511D>>

The input/output panel 700TP2 described in this embodiment includes a conductive film 511D (see FIG. 18).

Note that the conductive material CP or the like can be provided between the control line CL(g) and the conductive film 511D to electrically connect the control line CL(g) and the conductive film 511D. Alternatively, the conductive material CP or the like can be provided between the sensor signal line ML(h) and the conductive film 511D to electrically connect the sensor signal line ML(h) and the conductive film 511D. A material that can be used for the wiring or the like can be used for the conductive film 511D, for example.

### <<Terminal 519D>>

The input/output panel 700TP2 described in this embodiment includes a terminal 519D. The terminal 519D is electrically connected to the conductive film 511D.

For example, a material that can be used for the wiring or the like can be used for the terminal 519D. Specifically, the terminal 519D can have the same structure as that of the terminal 519B or the terminal 519C (see FIG. 18).

Note that the terminal 519D can be electrically connected to a flexible printed circuit FPC2 using a conductive material ACF2, for example. Thus, a control signal can be supplied to the control line CL(g) with the use of the terminal 519D, for example. Alternatively, a sensor signal can be supplied from the sensor signal line ML(h) with the use of the terminal 519D.

### <<Switch SW1, Transistor M, and Transistor MD>>

A transistor that can be used as the switch SW1, the transistor M, and the transistor MD include the conductive film 504 including a region overlapping with the insulating film 501C and the semiconductor film 508 including a region located between the insulating film 501C and the conductive film 504. Note that the conductive film 504 serves as a gate electrode (see FIG. 17B).

The semiconductor film 508 includes a first region 508A, a second region 508B, and a third region 508C. The first region 508A and the second region 508B do not overlap with the conductive film 504. The third region 508C is positioned between the first region 508A and the second region 508B and overlaps with the conductive film 504.

The transistor MD includes the insulating film 506 between the third region 508C and the conductive film 504. Note that the insulating film 506 functions as a gate insulating film.

The first region 508A and the second region 508B have a lower resistivity than the third region 508C, and function as a source region and a drain region.

For example, plasma treatment using a gas containing a rare gas is performed on an oxide semiconductor film, whereby the first region 508A and the second region 508B can be formed in the semiconductor film 508.

For example, the conductive film 504 can be used as a mask. The use of the conductive film 504 as a mask allows the shape of part of the third region 508C to be self-aligned with the shape of an end of the conductive film 504.

The transistor MD includes the conductive film 512A and the conductive film 512B that are in contact with the first region 508A and the second region 508B, respectively. The conductive film 512A and the conductive film 512B function as a source electrode and a drain electrode.

For example, a transistor that can be fabricated in the same process as the transistor MD can be used as the transistor M.

### <Structural Example 2 of Input/Output Panel>

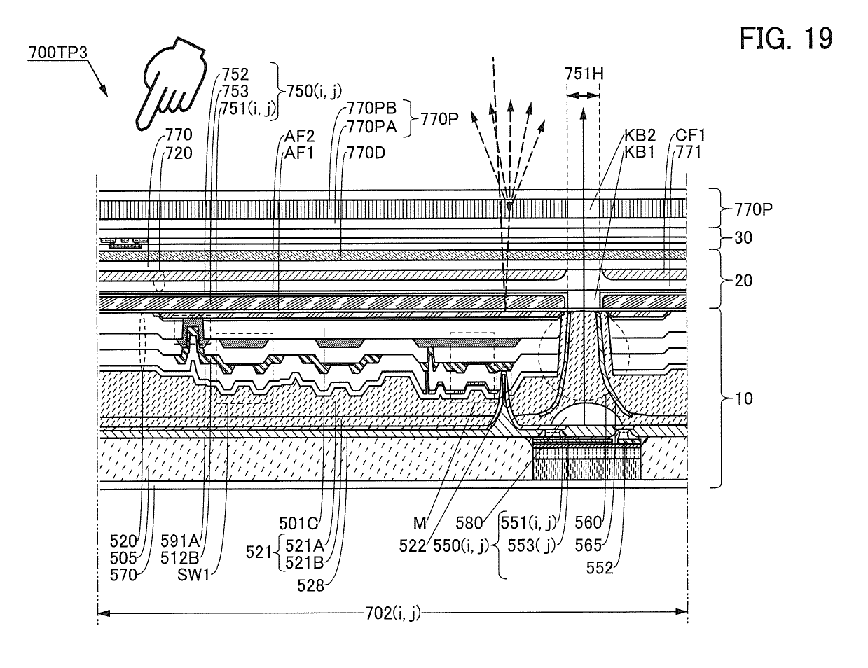

The structure of an input/output panel of one embodiment of the present invention will be described with reference to FIG. 19.

FIG. 19 illustrates the structure of the input/output panel of one embodiment of the present invention. FIG. 19 is a cross-sectional view of a pixel included in the input/output panel.

An input/output panel 700TP3 described in this structural example includes the pixel 702(i,j) (see FIG. 19). The input/output panel 700TP3 includes a first unit 10, a second unit 20, an input unit 30, and the functional film 770P. The first unit 10 includes the functional layer 520, and the second unit 20 includes the functional layer 720.

<<Pixel 702(i,j)>>

The pixel 702(i,j) includes a portion of the functional layer 520, the first display element 750(i,j), and the second display element 550(i,j) (see FIG. 19).

The functional layer 520 includes the first conductive film, the second conductive film, the insulating film 501C, and the pixel circuit 530(i,j). The pixel circuit 530(i,j) that is not illustrated includes the transistor M, for example. The functional layer 520 includes the optical element 560, the covering film 565, and the lens 580. The functional layer 520 includes the insulating film 528 and the insulating film 521. A stack of the insulating film 521A and the insulating film 521B can be used as the insulating film 521.

For example, a material whose refractive index is around 1.55 can be used for the insulating film 521A or the insulating film 521B. Alternatively, a material whose refractive index is around 1.6 can be used for the insulating film 521A or the insulating film 521B. Alternatively, an acrylic resin or polyimide can be used for the insulating film 521A or the insulating film 521B.

The insulating film 501C includes a region positioned between the first conductive film and the second conductive film and has an opening 591A.

The first conductive film is electrically connected to the first display element 750(i,j). Specifically, the first conductive film is electrically connected to an electrode 751(i,j) of the first display element 750(i,j). The electrode 751(i,j) can be used as the first conductive film.

The second conductive film includes a region overlapping with the first conductive film. The second conductive film is electrically connected to the first conductive film through the opening 591A. For example, the conductive film 512B can be used as the second conductive film. The second conductive film is electrically connected to the pixel circuit 530(i,j). For example, a conductive film that functions as a source electrode or a drain electrode of a transistor used as the switch SW1 of the pixel circuit 530(i,j) can be used as the second conductive film. Note that the first conductive film electrically connected to the second conductive film in the opening 591A formed in the insulating film 501C can be referred to as a through electrode.

The second display element 550(i,j) is electrically connected to the pixel circuit 530(i,j). The second display element 550(i,j) has a function of emitting light toward the functional layer 520. The second display element 550(i,j) has a function of emitting light toward the lens 580 or the optical element 560, for example.

The second display element 550(i,j) is provided such that display using the second display element 550(i,j) can be seen from part of a region where display using the first display element 750(i,j) can be seen. For example, the electrode 751(i,j) of the first display element 750(i,j) includes the region 751H where light emitted from the second display element 550(i,j) is not blocked. Note that dashed arrows shown in FIG. 19 denote the directions in which external light is incident on and reflected by the first display element 750(i,j) that displays image data by controlling the intensity of external light reflection. In addition, a solid arrow shown in FIG. 19 denotes the direction in which the second display element 550(i,j) emits light to the part of the region where display using the first display element 750(i,j) can be seen.

Accordingly, display using the second display element can be seen from part of the region where display using the first display element can be seen. Alternatively, a user can see display without changing the attitude or the like of the input/output panel. Alternatively, an object color expressed by light reflected by the first display element and a light source color expressed by light emitted from the second display element can be mixed. Alternatively, an object color and a light source color can be used to display an image like a painting. Consequently, a novel input/output panel with high convenience or high reliability can be provided.

The first display element 750(i,j) includes the electrode 751(i,j), the electrode 752, and the layer 753 containing a liquid crystal material, for example. The first display element 750(i,j) further includes the alignment film AF1 and the alignment film AF2. Specifically, a reflective liquid crystal element can be used as the first display element 750(i,j).

For example, a transparent conductive film whose refractive index is around 2.0 can be used as the electrode 752 or the electrode 751(i,j). Specifically, an oxide containing indium, tin, and silicon can be used for the electrode 752 or the electrode 751(i,j). Alternatively, a material whose refractive index is around 1.6 can be used for the alignment film.

The second display element 550(i,j) includes the electrode 551(i,j), the electrode 552, and a multilayer film 553(j), for example. The electrode 551(i,j) is electrically connected to the pixel circuit 530(i,j) at the connection portion 522. Specifically, a light-emitting diode can be used as the second display element 550(i,j).

For example, a transparent conductive film having a refractive index of around 2.0 can be used for the electrode 551(i,j). Specifically, an oxide containing indium, tin, and silicon can be used for the electrode 551(i,j).

The optical element 560 has a light-transmitting property and includes a first region, a second region, and a third region.

The first region includes a region to which visible light is supplied from the second display element 550(i,j), the second region includes a region in contact with the covering film 565, and the third region has a function of emitting part of visible light. The third region has an area smaller than or equal to the area of the region of the first region to which visible light is supplied.

The covering film 565 has visible light reflectivity and has a function of reflecting part of visible light and supplying it to the third region.

For example, a metal can be used for the covering film 565. Specifically, a material containing silver can be used for the covering film 565. For example, a material containing silver, palladium, and the like or a material containing silver, copper, and the like can be used for the covering film 565.

### <<Functional Layer 720>>

The functional layer 720 includes a region positioned between the substrate 770 and the insulating film 501C. The functional layer 720 further includes the insulating film 771 and the coloring film CF1.

The coloring film CF1 includes a region positioned between the substrate 770 and the first display element 750(i,j).

The insulating film 771 includes a region positioned between the coloring film CF1 and the layer 753 containing a liquid crystal material. The insulating film 771 can reduce unevenness due to the thickness of the coloring film CF1. Furthermore, the insulating film 771 can prevent impurities from diffusing from the coloring film CF1 or the like to the layer 753 containing a liquid crystal material.

For example, an acrylic resin whose refractive index is around 1.55 can be used for the insulating film 771.

### <<Substrate 570 and Substrate 770>>

The input/output panel described in this embodiment includes the substrate 570 and the substrate 770.

The substrate 770 includes a region overlapping with the substrate 570. The substrate 770 includes a region provided such that the functional layer 520 is positioned between the substrate 770 and the substrate 570.

The substrate 770 includes a region overlapping with the first display element 750(i,j). For example, a material with low birefringence can be used for the region.

For example, a resin material whose refractive index is around 1.5 can be used for the substrate 770.

### <<Bonding Layer 505>>

The input/output panel described in this embodiment also includes the bonding layer 505.

The bonding layer 505 includes a region positioned between the functional layer 520 and the substrate 570, and has a function of bonding the functional layer 520 and the substrate 570 to each other.

### <<Structure Bodies KB1 and KB2>>

The input/output panel described in this embodiment includes the structure body KB1 and a structure body KB2.

The structure body KB1 has a function of providing a certain space between the functional layer 520 and the substrate 770. The structure body KB1 includes a region overlapping with the region 751H and has a light-transmitting property. Thus, light emitted from the second display element 550(i,j) can be supplied to one surface of the structure body KB1 and extracted from the other surface.

Furthermore, the structure body KB1 includes a region overlapping with the optical element 560 and is formed using a material whose refractive index is different from that of a material used for the optical element 560 by 0.2 or less, for example. Accordingly, light emitted from the second display element can be used efficiently. Alternatively, the area of the second display element can be increased. Alternatively, the density of a current supplied to a light-emitting diode can be decreased.

The structure body KB2 has a function of controlling the thickness of a polarizing layer 770PB to be a predetermined thickness. The structure body KB2 includes a region overlapping with the second display element 550(i,j) and has a light-transmitting property.

A material that transmits light of a predetermined color may be used for the structure body KB1 or KB2. Thus, the structure body KB1 or KB2 can be used as a color filter, for example. For example, a material that transmits blue light, green light, or red light can be used for the structure body KB1 or KB2. Alternatively, a material that transmits yellow light, white like, or the like can be used for the structure body KB1 or KB2.

Specifically, polyester, polyolefin, polyamide, polyimide, polycarbonate, polysiloxane, an acrylic resin, or the like, or a composite material of a plurality of kinds of resins selected from these can be used for the structure bodies KB1 and KB2. Alternatively, a photosensitive material may be used.

For example, an acrylic resin whose refractive index is around 1.5 can be used for the structure body KB1. An acrylic resin whose refractive index is around 1.55 can be used for the structure body KB2.

### <<Input Unit 30>>

The input unit 30 includes a sensor element. The sensor element has a function of sensing an object that approaches a region overlapping with the pixel 702(i,j). Accordingly, a finger or the like that approaches the display portion can be used as a pointer to input positional data.

For example, a capacitive proximity sensor, an electromagnetic inductive proximity sensor, an optical proximity sensor, a resistive proximity sensor, or a surface acoustic wave proximity sensor can be used as the input unit 30. Specifically, a surface capacitive proximity sensor, a projected capacitive proximity sensor, or an infrared proximity sensor can be used.

For example, a touch sensor which includes a capacitive proximity sensor and whose refractive index is around 1.6 can be used as the input unit 30.

### <<Functional Films 770D and 770P and Other Components>>

The input/output panel 700TP3 described in this embodiment includes the functional film 770D and the functional film 770P.

The functional film 770D includes a region overlapping with the first display element 750(i,j). The functional film 770D includes a region provided such that the first display element 750(i,j) is positioned between the functional film 770D and the functional layer 520.

For example, a light diffusion film can be used as the functional film 770D. Specifically, a material with a columnar structure having an axis along the direction intersecting a surface of a base can be used for the functional film 770D. In that case, light can be easily transmitted in the direction along the axis and easily scattered in other directions. For example, light reflected by the first display element 750(i,j) can be diffused.

The functional film 770P includes the polarizing layer 770PB, a retardation film 770PA, and the structure body KB2. The polarizing layer 770PB includes an opening, and the retardation film 770PA includes a region overlapping with the polarizing layer 770PB. Note that the structure body KB2 is provided in the opening.

For example, a dichromatic pigment, a liquid crystal material, and a resin can be used for the polarizing layer 770PB. The polarizing layer 770PB has a polarization property. In that case, the functional film 770P can be used as a polarizing plate.

The polarizing layer 770PB includes a region overlapping with the first display element 750(i,j), and the structure body KB2 includes a region overlapping with the second display element 550(i,j). Thus, a liquid crystal element can be used as the first display element. For example, a reflective liquid crystal element can be used as the first display element. Alternatively, light emitted from the second display element can be extracted efficiently. Alternatively, the density of a current supplied to a light-emitting diode can be decreased. Alternatively, the reliability of a light-emitting diode can be increased.

For example, an anti-reflection film, a polarizing film, or a retardation film can be used as the functional film 770P. Specifically, a film containing a dichromatic pigment and a retardation film can be used as the functional film 770P.

Alternatively, an antistatic film preventing the attachment of a foreign substance, a water repellent film suppressing the attachment of stain, a hard coat film suppressing a scratch in use, or the like can be used as the functional film 770P.

For example, a material whose refractive index is around 1.6 can be used for a diffusion film. A material whose refractive index is around 1.6 can be used for the retardation film 770PA.

Note that this embodiment can be combined with any of the other embodiments in this specification as appropriate.

### Embodiment 5

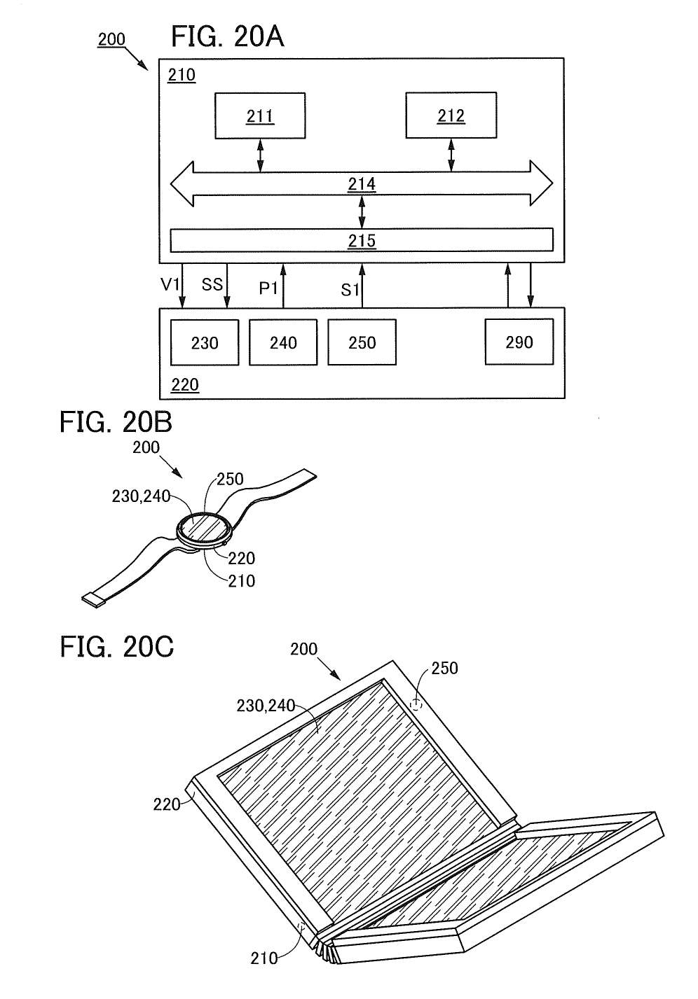

In this embodiment, the structure of a data processing device of one embodiment of the present invention will be described with reference to FIGS. 20A to 20C, FIGS. 21A and 21B, and FIG. 22.

FIG. 20A is a block diagram illustrating the structure of the data processing device of one embodiment of the present invention. FIGS. 20B and 20C are projection views each illustrating an example of an external view of the data processing device 200.

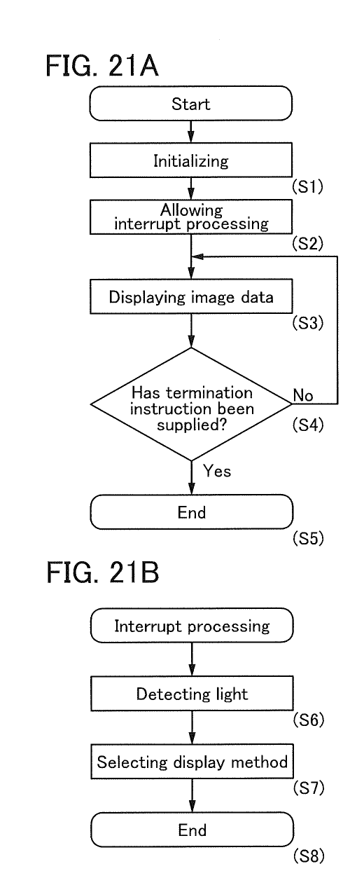

FIGS. 21A and 21B are flow charts showing a program of one embodiment of the present invention. FIG. 21A is a flow chart showing main processing of the program of one embodiment of the present invention. FIG. 21B is a flow chart showing interrupt processing.

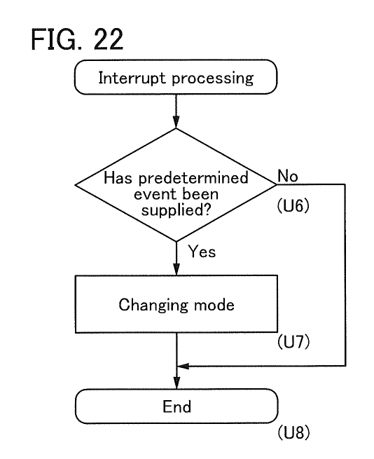

FIG. 22 is a flow chart showing interrupt processing of the program of one embodiment of the present invention.

### <Structural Example 1 of Data Processing Device>

The data processing device 200 described in this embodiment includes an input/output device 220 and an arithmetic device 210 (see FIG. 20A). The input/output device 220 is electrically connected to the arithmetic device 210. Furthermore, the data processing device 200 can include a housing (see FIG. 20B or 20C).

The input/output device 220 includes the display portion 230 and the input portion 240 (see FIG. 20A). The input/output device 220 includes a sensor portion 250. The input/output device 220 can include a communication portion 290.

The input/output device 220 has a function of receiving the image data V1 or the control data SS and a function of supplying the positional data P1 or sensing data S1.

The arithmetic device 210 has a function of receiving the positional data P1 or the sensing data S1. The arithmetic device 210 has a function of supplying the image data V1. The arithmetic device 210 has a function of operating on the basis of the positional data P1 or the sensing data S1.

Note that the housing has a function of housing the input/output device 220 or the arithmetic device 210. Alternatively, the housing has a function of supporting the display portion 230 or the arithmetic device 210.

The display portion 230 has a function of displaying an image on the basis of the image data V1. The display portion 230 has a function of displaying an image on the basis of the control data SS.

The input portion 240 has a function of supplying the positional data P1.

The sensor portion 250 has a function of supplying the sensing data S1. The sensor portion 250 has a function of sensing the illuminance of the environment where the data processing device 200 is used and a function of supplying illuminance data, for example.

Thus, the data processing device can determine the intensity of light received by the housing of the data processing device and operate in a usage environment. Alternatively, a user of the data processing device can select a display method. Specifically, when a display method using the first display element is selected, power consumption can be reduced, for example. Alternatively, when a display method using the second display element is selected, display can be performed in a dark place, for example. Alternatively, when a display method using the first display element 750(i,j) and the second display element 550(i,j) is selected, display that is based on the user's preference and comfortable for the user can be performed. Consequently, a novel data processing device with high convenience or high reliability can be provided.

Individual components included in the data processing device will be described below. Note that these components cannot be clearly distinguished from each other and one component may also serve as another component or include part of another component. For example, a touch panel in which a touch sensor is provided to overlap with a display panel serves as an input portion as well as a display portion.

### <<Structural Example>>

The data processing device 200 of one embodiment of the present invention includes a housing or the arithmetic device 210.

The arithmetic device 210 includes an arithmetic portion 211, a memory portion 212, a transmission path 214, and an input/output interface 215.

The data processing device of one embodiment of the present invention includes the input/output device 220.

The input/output device 220 includes the display portion 230, the input portion 240, the sensor portion 250, and the communication portion 290.

### <<Data Processing Device>>

The data processing device of one embodiment of the present invention includes the arithmetic device 210 and the input/output device 220.

### <<Arithmetic Device 210>>

The arithmetic device 210 includes the arithmetic portion 211 and the memory portion 212. The arithmetic device 210 also includes the transmission path 214 and the input/output interface 215.

### <<Arithmetic Portion 211>>

The arithmetic portion 211 has a function of executing a program, for example.

### <<Memory Portion 212>>

The memory portion 212 has a function of, for example, storing a program executed by the arithmetic portion 211, initial data, setting data, an image, or the like.

Specifically, a hard disk, a flash memory, a memory including a transistor including an oxide semiconductor, or the like can be used for the memory portion 212.

### <<Input/Output Interface 215 and Transmission Path 214>>

The input/output interface 215 includes a terminal or a wiring and has a function of supplying and receiving data. The input/output interface 215 can be electrically connected to the transmission path 214 and the input/output device 220.

The transmission path 214 includes a wiring and has a function of supplying and receiving data. For example, the transmission path 214 can be electrically connected to the input/output interface 215. In addition, the transmission path 214 can be electrically connected to the arithmetic portion 211 and the memory portion 212.

### <<Input/Output Device 220>>

The input/output device 220 includes the display portion 230, the input portion 240, the sensor portion 250, and the communication portion 290. For example, the input/output device described in Embodiment 3 can be used. In that case, power consumption can be reduced.

### <<Display Portion 230>>

The display portion 230 includes the control portion 238, the driver circuit GD, the driver circuit SD, and the display panel 700 (see FIG. 13A). For example, any of the display devices described in Embodiment 2 can be used for the display portion 230.

### <<Input Portion 240>>

Any of a variety of human interfaces or the like can be used as the input portion 240 (see FIGS. 20A to 20C).

For example, a keyboard, a mouse, a touch sensor, a microphone, a camera, or the like can be used as the input portion 240. Note that a touch sensor having a region overlapping with the display portion 230 can be used. An input/output device that includes the display portion 230 and a touch sensor having a region overlapping with the display portion 230 can be referred to as a touch panel or a touch screen.

For example, a user can make various gestures (e.g., tap, drag, swipe, and pinch in) using his/her finger as a pointer on the touch panel.

The arithmetic device 210, for example, analyzes data on the position, track, or the like of the finger on the touch panel and determines that a specific gesture is supplied when the analysis results meet predetermined conditions. Therefore, the user can supply a certain operation instruction associated with a predetermined gesture by using the gesture.

For instance, the user can supply a “scrolling instruction” for changing a portion where image data is displayed by using a gesture of touching and moving his/her finger on the touch panel.

### <<Sensor Portion 250>>

The sensor portion 250 has a function of sensing the ambient conditions and supplying the sensing data. Specifically, the sensor portion 250 can supply illuminance data, attitude data, pressure data, positional data, and the like.

For example, a photosensor, an attitude sensor, an acceleration sensor, a direction sensor, a global positioning system (GPS) signal receiving circuit, a pressure sensor, a temperature sensor, a humidity sensor, a camera, or the like can be used as the sensor portion 250.

### <<Communication Portion 290>>

The communication portion 290 has a function of supplying and acquiring data to/from a network.

### <<Program>>

The program of one embodiment of the present invention has the following steps (see FIG. 21A).

### [First Step]

In a first step, setting is initialized (see S1 in FIG. 21A).

For example, predetermined image data which is to be displayed on start-up and data for determining a predetermined mode of displaying the image data and a predetermined method of displaying the image data are acquired from the memory portion 212. Specifically, still image data or moving image data can be used as the predetermined image data. Furthermore, a first mode or a second mode can be used as the predetermined mode. Furthermore, a first display method, a second display method, or a third display method can be used as the predetermined display method.

### [Second Step]

In a second step, interrupt processing is allowed (see S2 in FIG. 21A). Note that an arithmetic device allowed to execute the interrupt processing can perform the interrupt processing in parallel with the main processing. The arithmetic device which has returned from the interrupt processing to the main processing can reflect the results of the interrupt processing in the main processing.

The arithmetic device may execute the interrupt processing when a counter has an initial value, and the counter may be set at a value other than the initial value when the arithmetic device returns from the interrupt processing. Thus, the interrupt processing is ready to be executed after the program is started up.

### [Third Step]

In a third step, image data is displayed in a predetermined mode or a predetermined display method selected in the first step or the interrupt processing (see S3 in FIG. 21A). Note that the predetermined mode identifies a mode for displaying the data, and the predetermined display method identifies a method for displaying image data. For example, the image data V1, the data V11, or the data V12 can be used for data to be displayed.

For example, a method for displaying the image data V1 can be associated with the first mode. Another method for displaying the image data V1 can be associated with the second mode. Thus, a display method can be selected on the basis of the selected mode.

For example, three different methods for displaying the image data V1 can be associated with the first display method to the third display method. Thus, display can be performed on the basis of the selected display method.

### <<First Mode>>

Specifically, a method of supplying selection signals to a scan line at a frequency of 30 Hz or more, preferably 60 Hz or more, and performing display in accordance with the selection signals can be associated with the first mode.

For example, the supply of selection signals at a frequency of 30 Hz or more, preferably 60 Hz or more, can display a smooth moving image.

For example, an image is refreshed at a frequency of 30 Hz or more, preferably 60 Hz or more, so that an image smoothly following the user's operation can be displayed on the data processing device 200 the user operates.

### <<Second Mode>>

Specifically, a method of supplying selection signals to a scan line at a frequency of less than 30 Hz, preferably less than 1 Hz, further preferably less than once a minute and performing display in accordance with the selection signals can be associated with the second mode.

The supply of selection signals at a frequency of less than 30 Hz, preferably less than 1 Hz, more preferably less than once a minute, can perform display with flickering reduced. Furthermore, power consumption can be reduced.

For example, when the data processing device 200 is used for a clock or watch, the display can be refreshed at a frequency of once a second, once a minute, or the like.

For example, when a light-emitting element is used as the second display element, the light-emitting element can be made to emit light in a pulsed manner so as to display image data. Specifically, a light-emitting diode can be made to emit light in a pulsed manner, and its afterglow can be used to display image data. A light-emitting diode has excellent frequency characteristics; therefore, time for driving the second display element can be shortened and thus power consumption can be reduced in some cases. Alternatively, heat generation can be inhibited, and thus the deterioration of the light-emitting diode can be suppressed in some cases.

### <<First Display Method>>

Specifically, a method in which the first display element 750(i,j) is used to display image data can be used as the first display method. Thus, for example, power consumption can be reduced. Furthermore, image data with high contrast can be favorably displayed in a bright environment.

### <<Second Display Method>>

Specifically, a method in which the second display element 550(i,j) is used to display image data can be used as the second display method. Thus, for example, an image can be favorably displayed in a dark environment. Furthermore, a photograph and the like can be displayed with favorable color reproducibility. Furthermore, a moving image that moves fast can be displayed smoothly.

In the case where the image data V1 is displayed using the second display element 550(i,j), brightness for displaying the image data V1 can be determined on the basis of illuminance data. For example, when illuminance is higher than or equal to 5,000 lux and less than 100,000 lux, the image data V1 is displayed using the second display element 550(i,j) to be bright compared with the case where the illuminance is less than 5,000 lux.

### <<Third Display Method>>

Specifically, a method in which the first display element 750(i,j) and the second display element 550(i,j) are used to display image data can be used as the third display method. In that case, power consumption can be reduced. Furthermore, an image can be favorably displayed in a dark environment. Furthermore, a photograph and the like can be displayed with favorable color reproducibility. Furthermore, a moving image which moves fast can be displayed smoothly. Furthermore, display comfortable for the user can be achieved.

Note that a function of adjusting the brightness of display by using the first display element 750(i,j) and the second display element 550(i,j) to display image data can be referred to as a light adjusting function. For example, the brightness of a reflective display element can be complemented using the display element having a function of emitting light.

Note that a function of adjusting the color of display by using the first display element 750(i,j) and the second display element 550(i,j) can be referred to as a color adjusting function. For example, the color of a reflective display element can be changed using the display element having a function of emitting light. Specifically, a yellowish color displayed by a reflective liquid crystal element can be made closer to a white color with the use of a blue light-emitting diode. Thus, text data can be displayed like text printed on plain paper, for example. Furthermore, eye-friendly display can be achieved.

When the first display element 750(i,j) and the second display element 550(i,j) are used to display image data, a color reflected by an object and a color emitted from an object are mixed. Thus, an image like a painting can be displayed.

Note that the brightness of the image data V1 displayed using the second display element 550(i,j) and overlapping with the image data V1 displayed using the first display element 750(i,j) can be determined on the basis of illuminance data and the user's preference. This allows display comfortable for the user.

### [Fourth Step]

In a fourth step, the next step is determined as follows: a fifth step is selected when a termination instruction has been supplied, whereas the third step is selected when the termination instruction has not been supplied (see S4 in FIG. 21A).

For example, the termination instruction supplied in the interrupt processing can be used to determine the next step.

### [Fifth Step]

In the fifth step, the program terminates (see S5 in FIG. 21A).

### <<Interrupt Processing>>

The interrupt processing includes sixth to eighth steps described below (see FIG. 21B).

### [Sixth Step]

In the sixth step, the illuminance of the environment where the data processing device 200 is used can be sensed using the sensor portion 250, for example (see S6 in FIG. 21B). Note that the color temperature or chromaticity of ambient light can be sensed instead of the illuminance of the environment.

### [Seventh Step]

In the seventh step, a display method is determined on the basis of the sensed illuminance data. For example, the first display method is selected when the illuminance is greater than or equal to a predetermined value, whereas the second display method is selected when the illuminance is less than the predetermined value. Furthermore, the third display method may be selected when the illuminance is within a predetermined range (see S7 in FIG. 21B).

Specifically, in the case where the illuminance is greater than or equal to 100,000 lux, the first display method may be selected. In the case where the illuminance is less than 5,000 lux, the second display method may be selected. In the case where the illuminance is greater than or equal to 5,000 lux and less than 100,000 lux, the third display method may be selected.

In the case where the color temperature or chromaticity of the ambient light is sensed in the sixth step, the color of display may be adjusted using the second display element 550(i,j) by the third display method.

For example, first-status control data SS is supplied when the first display method is used, second-status control data SS is supplied when the second display method is used, and third-status control data SS is supplied when the third display method is used.

### [Eighth Step]

In the eighth step, the interrupt processing terminates (see S8 in FIG. 21B).

### <Structural Example 2 of Data Processing Device>

Another structure of the data processing device of one embodiment of the present invention will be described with reference to FIG. 22.

FIG. 22 is a flow chart showing a program of one embodiment of the present invention. The interrupt processing in the flow chart in FIG. 22 is different from that in FIG. 21B.

Note that the structural example 2 of the data processing device is different from the interrupt processing in FIG. 21B in that the interrupt processing includes a step in which a mode is changed on the basis of a supplied predetermined event. Different structures will be described in detail below, and the above description is referred to for the similar portions.

### <<Interrupt Processing>>

The interrupt processing includes sixth to eighth steps described below (see FIG. 22).

### [Sixth Step]

In the sixth step, the processing proceeds to the seventh step when a predetermined event has been supplied, whereas the processing proceeds to the eighth step when the predetermined event has not been supplied (see U6 in FIG. 22). For example, whether the predetermined event is supplied in a predetermined period or not can be a branch condition. Specifically, the predetermined period can be longer than 0 seconds and shorter than or equal to 5 seconds, preferably shorter than or equal to 1 second, more preferably shorter than or equal to 0.5 seconds, still more preferably shorter than or equal to 0.1 seconds.

### [Seventh Step]

In the seventh step, the mode is changed (see U7 in FIG. 22). Specifically, the mode is changed to the second mode when the first mode has been selected, or the mode is changed to the first mode when the second mode has been selected.

### [Eighth Step]

In the eighth step, the interrupt processing terminates (see U8 in FIG. 22). Note that in a period in which the main processing is executed, the interrupt processing may be repeatedly executed.

### <<Predetermined Event>>

For example, the following events can be used: events supplied using a pointing device such as a mouse (e.g., “click” and “drag”) and events supplied to a touch panel with a finger or the like used as a pointer (e.g., “tap”, “drag”, and “swipe”).

For example, the position of a slide bar pointed by a pointer, the swipe speed, and the drag speed can be used as parameters assigned to various instructions. Furthermore, for example, the position of a slide bar pointed by a pointer, the swipe speed, and the drag speed can be used as parameters assigned to an instruction associated with a predetermined event.

For example, data sensed by the sensor portion 250 is compared to a predetermined threshold value, and the compared results can be used for the event.

Specifically, a pressure sensor or the like in contact with a button or the like that can be pushed in a housing can be used as the sensor portion 250.

<<Instruction Associated with Predetermined Event>>

For example, the termination instruction can be associated with a predetermined event.

For example, “page-turning instruction” for switching displayed image data from one to another can be associated with a predetermined event. Note that a parameter for determining the page-turning speed or the like when the “page-turning instruction” is executed can be supplied using the predetermined event.

For example, “scroll instruction” for moving the display position of part of image data and displaying another part continuing from that part can be associated with a predetermined event. Note that a parameter for determining the moving speed of the display position, or the like, when the “scroll instruction” is executed can be supplied using the predetermined event.

For example, an instruction for setting the display method or an instruction for generating image data can be associated with a predetermined event. Note that a parameter for determining the brightness of a generated image can be associated with a predetermined event. Note that a parameter for determining the brightness of a generated image may be determined on the basis of ambient brightness sensed by the sensor portion 250.

For example, an instruction for acquiring data distributed via a push service using the communication portion 290 can be associated with a predetermined event.

Note that positional data sensed by the sensor portion 250 may be used for the determination of the presence or absence of a qualification for acquiring data. Specifically, it may be determined that there is a qualification for acquiring data when a user is in a predetermined class room, school, conference room, office, building, or the like. For example, educational materials can be fed from a classroom of a school or a university, so that the data processing device 200 can be used as a schoolbook or the like (see FIG. 20C). Alternatively, materials distributed from a conference room in, for example, a company can be received and used for a conference material.

Note that this embodiment can be combined with any of the other embodiments in this specification as appropriate.

### Embodiment 6

In this embodiment, a display module that can be fabricated using one embodiment of the present invention will be described.

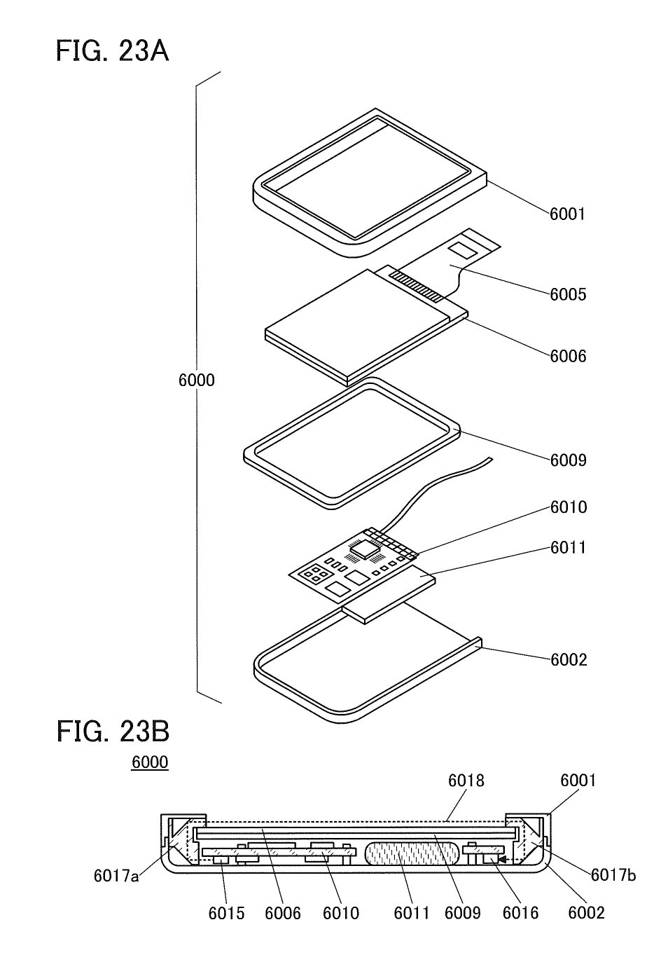

In a display module 6000 in FIG. 23A, a display panel 6006 connected to an FPC 6005, a frame 6009, a printed board 6010, and a battery 6011 are provided between an upper cover 6001 and a lower cover 6002.

For example, the display device manufactured using one embodiment of the present invention can be used for the display panel 6006. Thus, the display module can be manufactured with high yield.

The shapes and sizes of the upper cover 6001 and the lower cover 6002 can be changed as appropriate in accordance with the size of the display panel 6006.

A touch panel may be provided to overlap with the display panel 6006. The touch panel can be a resistive touch panel or a capacitive touch panel and may be formed to overlap with the display panel 6006. Instead of providing a touch panel, the display panel 6006 can have a touch panel function.

The frame 6009 protects the display panel 6006 and functions as an electromagnetic shield for blocking electromagnetic waves generated by the operation of the printed board 6010. The frame 6009 may function as a radiator plate.

The printed board 6010 is provided with a power supply circuit and a signal processing circuit for outputting a video signal and a clock signal. As a power source for supplying power to the power supply circuit, an external commercial power source or a power source using the battery 6011 provided separately may be used. The battery 6011 can be omitted in the case of using a commercial power source.

The display module 6000 may be additionally provided with a member such as a polarizing plate, a retardation plate, or a prism sheet.

FIG. 23B is a schematic cross-sectional view of the display module 6000 with an optical touch sensor.

The display module 6000 includes a light-emitting portion 6015 and a light-receiving portion 6016 that are provided on the printed board 6010. A pair of light guide portions (a light guide portion 6017a and a light guide portion 6017b) is provided in a region surrounded by the upper cover 6001 and the lower cover 6002.

For example, a plastic or the like can be used for the upper cover 6001 and the lower cover 6002. The upper cover 6001 and the lower cover 6002 can each be thin (e.g., more than or equal to 0.5 mm and less than or equal to 5 mm). Therefore, the display module 6000 can be significantly lightweight. In addition, the upper cover 6001 and the lower cover 6002 can be manufactured with a small amount of material, and therefore, manufacturing cost can be reduced.

The display panel 6006 overlaps with the printed board 6010 and the battery 6011 with the frame 6009 therebetween. The display panel 6006 and the frame 6009 are fixed to the light guide portion 6017a and the light guide portion 6017b.

Light 6018 emitted from the light-emitting portion 6015 travels over the display panel 6006 through the light guide portion 6017a and reaches the light-receiving portion 6016 through the light guide portion 6017b. For example, blocking of the light 6018 by a sensing target such as a finger or a stylus can be detected as touch operation.

A plurality of light-emitting portions 6015 are provided along two adjacent sides of the display panel 6006, for example. A plurality of light-receiving portions 6016 are provided to face the light-emitting portions 6015 with the display panel 6006 therebetween. Accordingly, data on the position of touch operation can be obtained.

As the light-emitting portion 6015, a light source such as an LED element can be used. It is particularly preferable to use a light source that emits infrared light, which is not visually recognized by users and is harmless to users, as the light-emitting portion 6015.

As the light-receiving portion 6016, a photoelectric element that receives light emitted by the light-emitting portion 6015 and converts it into an electrical signal can be used. A photodiode that can receive infrared light can be favorably used.

For the light guide portions 6017a and 6017b, members that transmit at least the light 6018 can be used. The use of the light guide portions 6017a and 6017b allows the light-emitting portion 6015 and the light-receiving portion 6016 to be placed under the display panel 6006, and a malfunction of the touch sensor due to external light reaching the light-receiving portion 6016 can be suppressed. It is particularly preferable to use a resin that absorbs visible light and transmits infrared light. This is more effective in suppressing the malfunction of the touch sensor.

Note that this embodiment can be combined with any of the other embodiments in this specification as appropriate.

### Embodiment 7

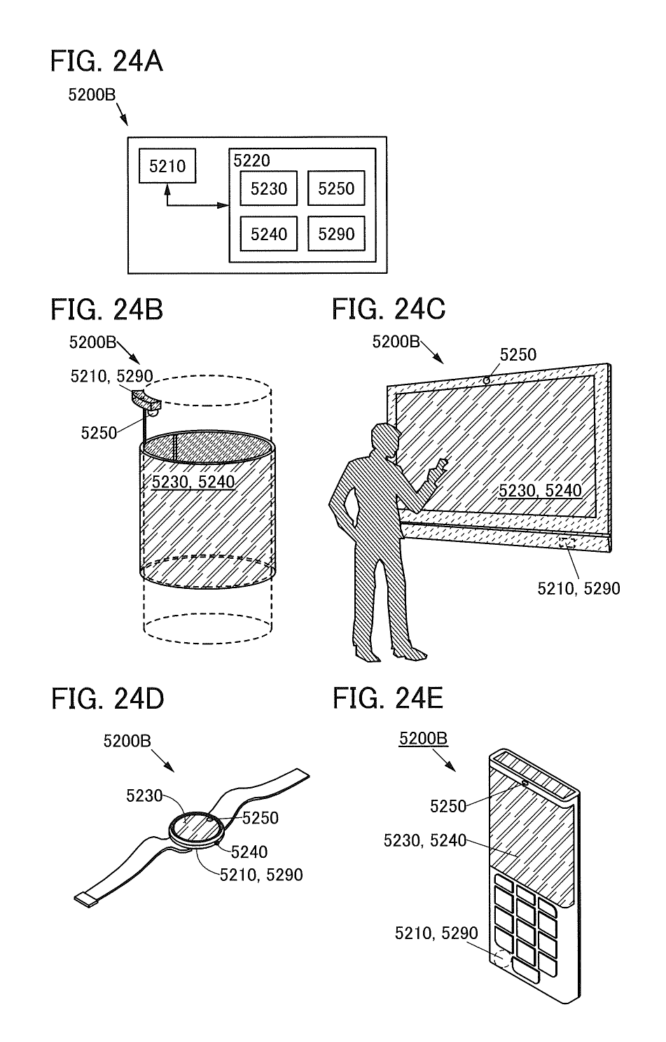

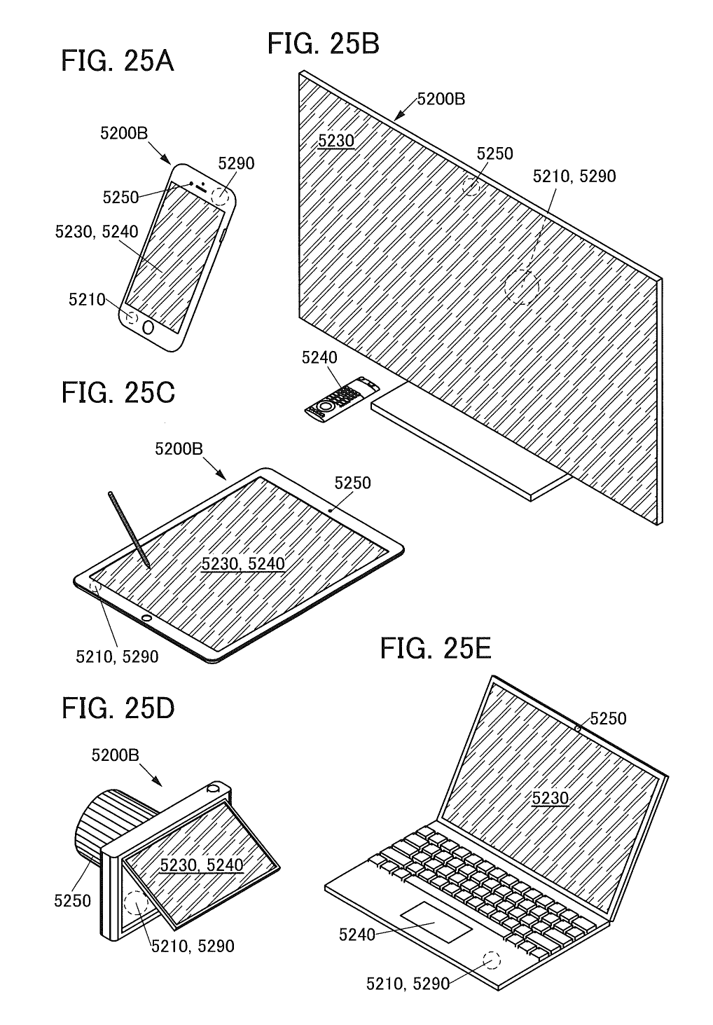

In this embodiment, the structures of data processing devices of embodiments of the present invention will be described with reference to FIGS. 24A to 24E and FIGS. 25A to 25E.

FIGS. 24A to 24E and FIGS. 25A to 25E illustrate the structures of the data processing devices of embodiments of the present invention. FIG. 24A is a block diagram of the data processing device, and FIGS. 24B to 24E are perspective views illustrating the structures of the data processing devices. FIGS. 25A to 25E are perspective views illustrating the structures of the data processing devices.

### <Data Processing Device>

A data processing device 5200B described in this embodiment includes an arithmetic device 5210 and an input/output device 5220 (see FIG. 24A).

The arithmetic device 5210 has a function of receiving control data and a function of supplying image data on the basis of the control data.

The input/output device 5220 includes a display portion 5230, an input portion 5240, a sensor portion 5250, and a communication portion 5290 and has a function of supplying control data and a function of receiving image data. The input/output device 5220 also has a function of supplying sensing data, a function of supplying communication data, and a function of receiving communication data.

The input portion 5240 has a function of supplying control data. For example, the input portion 5240 supplies control data on the basis of control by the user of the data processing device 5200B.

Specifically, a keyboard, a hardware button, a pointing device, a touch sensor, an audio input device, a viewpoint input device, or the like can be used as the input portion 5240.

The display portion 5230 includes a display panel and has a function of displaying image data. For example, the display panel described in Embodiment 1 can be used for the display portion 5230.

The sensor portion 5250 has a function of supplying sensing data. For example, the sensor portion 5250 has a function of sensing a surrounding environment where the data processing device is used and supplying sensing data.

Specifically, an illuminance sensor, an imaging device, an attitude determination device, a pressure sensor, a human motion sensor, or the like can be used as the sensor portion 5250.

The communication portion 5290 has a function of receiving and supplying communication data. For example, the communication portion 5290 has a function of being connected to another electronic device or a communication network by wireless communication or wired communication. Specifically, the communication portion 5290 has a function of local area wireless communication, telephone communication, or near field wireless communication, for example.

### <<Structural Example 1 of Data Processing Device>>

For example, the display portion 5230 can have an outer shape along a cylindrical column (see FIG. 24B). Furthermore, the display portion 5230 has a function of changing a displaying method in accordance with the illuminance of a usage environment and a function of changing display data when sensing the existence of a person.

Thus, the data processing device 5200B can be mounted on a column of a building or can display advertisements.

### <<Structural Example 2 of Data Processing Device>>

For example, the data processing device 5200B has a function of generating image data on the basis of the path of a pointer used by a user (see FIG. 24C). Thus, the data processing device 5200B can be used as an electronic blackboard, for example.

### <<Structural Example 3 of Data Processing Device>>

For example, the data processing device 5200B has a function of changing a displaying method in accordance with the illuminance of a usage environment (see FIG. 24D). Thus, the power consumption of a smartwatch can be reduced. Furthermore, a smartwatch that allows users to favorably see display even outdoors on a sunny day can be provided.

### <<Structural Example 4 of Data Processing Device>>

The display portion 5230 has a surface gently curved along a side surface of a housing (see FIG. 24E). The display portion 5230 includes a display panel that has, for example, a function of performing display on the front surface, side surfaces, and the top surface. Thus, a portable phone that can display image data on the front surface, side surfaces, and the top surface can be provided.

### <<Structural Example 5 of Data Processing Device>>

For example, the data processing device 5200B has a function of changing a displaying method in accordance with the illuminance of a usage environment (see FIG. 25A). Thus, the power consumption of a smartphone can be reduced.

### <<Structural Example 6 of Data Processing Device>>

For example, the data processing device 5200B has a function of changing a displaying method in accordance with the illuminance of a usage environment (see FIG. 25B). Thus, a television system that allows users to favorably view an image even in an environment with high-intensity external light can be provided.

### <<Structural Example 7 of Data Processing Device>>

For example, the data processing device 5200B has a function of changing a displaying method in accordance with the illuminance of a usage environment (see FIG. 25C). Thus, the data processing device 5200B can be used for an eye-friendly tablet computer.

### <<Structural Example 8 of Data Processing Device>>

For example, the data processing device 5200B has a function of changing a displaying method in accordance with the illuminance of a usage environment (see FIG. 25D). Thus, a digital camera that can favorably display a subject even in an environment with high-intensity external light can be provided.

### <<Structural Example 9 of Data Processing Device>>

For example, the data processing device 5200B has a function of changing a displaying method in accordance with the illuminance of a usage environment (see FIG. 25E). Thus, a personal computer that can be favorably used even in an environment with high-intensity external light can be provided.

Note that this embodiment can be combined with any of the other embodiments in this specification as appropriate.

### Embodiment 8

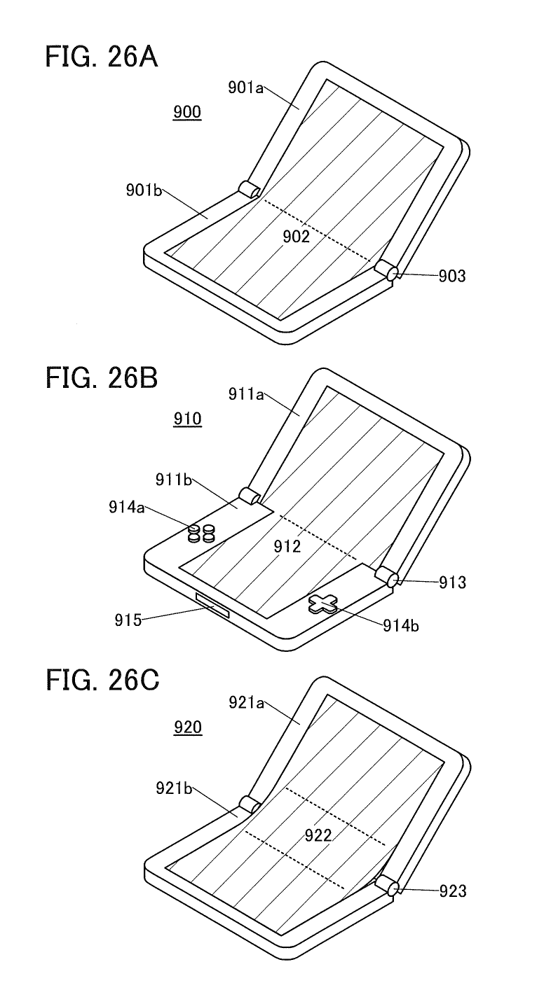

In this embodiment, the structures of electronic devices of embodiments of the present invention will be described with reference to FIGS. 26A to 26C.

### <Electronic Device>

FIGS. 26A to 26C illustrate foldable electronic devices.

An electronic device 900 illustrated in FIG. 26A includes a housing 901a, a housing 901b, a hinge 903, a display portion 902, and the like. The display portion 902 is incorporated in the housing 901a and the housing 901b.

The housing 901a and the housing 901b are rotatably joined to each other by the hinge 903. The electronic device 900 can be changed in shape between a state where the housing 901a and the housing 901b are closed and a state where the housing 901a and the housing 901b are opened as illustrated in FIG. 26A. Thus, the electronic device 900 has high portability when carried and excellent visibility when used because of its large display region.

The hinge 903 preferably includes a locking mechanism so that an angle formed between the housing 901a and the housing 901b does not become larger than a predetermined angle when the housing 901a and the housing 901b are opened. For example, an angle at which they become locked (they are not opened any further) can be preferably greater than or equal to 90° and less than 180° and is typically 90°, 120°, 135°, 150°, 175°, or the like. In that case, the convenience, the safety, and the reliability can be improved.

The display portion 902 can function as a touch panel and be controlled with a finger, a stylus, or the like.

Either of the housing 901a and the housing 901b is provided with a wireless communication module, and data can be transmitted and received through a computer network such as the Internet, a local area network (LAN), or Wi-Fi®.

One flexible display is preferably incorporated in the display portion 902. In that case, an image can be displayed continuously between the housing 901a and the housing 901b. Note that each of the housing 901a and the housing 901b may be provided with a display.

FIG. 26B illustrates an electronic device 910 that functions as a portable game console. The electronic device 910 includes a housing 911a, a housing 911b, a display portion 912, a hinge 913, an operation button 914a, an operation button 914b, and the like.

A cartridge 915 can be inserted into the housing 911b. The cartridge 915 stores application software such as a game, for example, and a variety of applications can be executed on the electronic device 910 by replacing the cartridge 915.

FIG. 26B illustrates an example where a part of the display portion 912 that overlaps with the housing 911a and the other part of the display portion 912 that overlaps with the housing 911b have different sizes. Specifically, a portion of the display portion 912 that is provided on the housing 911a is larger than a portion of the display portion 912 that overlaps with the housing 911b where the operation buttons 914a and 914b are provided. For example, the portions of the display portion can be used for different purposes by performing display using the part of the display portion 912 on the housing 911a side as a main screen and the part of the display portion 912 on the housing 911b side as an operation screen.

In an electronic device 920 illustrated in FIG. 26C, a flexible display portion 922 is provided across a housing 921a and a housing 921b which are joined to each other by a hinge 923.

In FIG. 26C, the display portion 922 is greatly curved with the housing 921a and the housing 921b open. For example, the display portion 922 is held with a curvature radius of 1 mm or greater and 50 mm or less, preferably 5 mm or greater and 30 mm or less. Part of the display portion 922 can display an image while being bent since pixels are arranged continuously from the housing 921a to the housing 921b.

Since the hinge 923 includes the above locking mechanism, excessive force is not applied to the display portion 922; thus, breakage of the display portion 922 can be prevented. Consequently, a highly reliable electronic device can be obtained.

At least part of this embodiment can be implemented in combination with any of the other embodiments described in this specification as appropriate.

For example, in this specification and the like, an explicit description “X and Y are connected” means that X and Y are electrically connected, X and Y are functionally connected, and X and Y are directly connected. Accordingly, without limitation to a predetermined connection relation, for example, a connection relation shown in drawings or text, another connection relation is included in the drawings or the text.

Here, X and Y each denote an object (e.g., a device, an element, a circuit, a wiring, an electrode, a terminal, a conductive film, or a layer).

Examples of the case where X and Y are directly connected include the case where an element that allows an electrical connection between X and Y (e.g., a switch, a transistor, a capacitor, an inductor, a resistor, a diode, a display element, a light-emitting element, and a load) is not connected between X and Y, that is, the case where X and are connected without the element that allows the electrical connection between X and Y provided therebetween.

For example, in the case where X and Y are electrically connected, one or more elements that enable electrical connection between X and Y (e.g., a switch, a transistor, a capacitor, an inductor, a resistor, a diode, a display element, a light-emitting element, and a load) can be connected between X and Y. A switch is controlled to be on or off. That is, a switch is conducting or not conducting (is turned on or off) to determine whether a current flows therethrough or not. Alternatively, the switch has a function of selecting and changing a current path. Note that the case where X and Y are electrically connected includes the case where X and Y are directly connected.

For example, in the case where X and Y are functionally connected, one or more circuits that enable functional connection between X and Y (e.g., a logic circuit such as an inverter, a NAND circuit, or a NOR circuit; a signal converter circuit such as a DA converter circuit, an AD converter circuit, or a gamma correction circuit; a potential level converter circuit such as a power supply circuit (e.g., a step-up circuit and a step-down circuit) or a level shifter circuit for changing the potential level of a signal; a voltage source; a current source; a switching circuit; an amplifier circuit such as a circuit that can increase signal amplitude, the amount of current, or the like, an operational amplifier, a differential amplifier circuit, a source follower circuit, or a buffer circuit; a signal generation circuit; a memory circuit; and/or a control circuit) can be connected between X and Y. Note that for example, in the case where a signal output from X is transmitted to Y even when another circuit is interposed between X and Y, X and Y are functionally connected. Note that the case where X and Y are functionally connected includes the case where X and Y are directly connected and X and Y are electrically connected.

Note that in this specification and the like, an explicit description “X and Y are electrically connected” means that X and Y are electrically connected (i.e., the case where X and Y are connected with another element or another circuit provided therebetween), X and Y are functionally connected (i.e., the case where X and Y are functionally connected with another circuit provided therebetween), and X and Y are directly connected (i.e., the case where X and Y are connected without another element or another circuit provided therebetween). That is, in this specification and the like, the explicit description “X and Y are electrically connected” is the same as the description “X and Y are connected”.

Note that, for example, the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to a part of Z1 and another part of Z1 is directly connected to X while a drain (or a second terminal or the like) of the transistor is directly connected to a part of Z2 and another part of Z2 is directly connected to Y, can be expressed by using any of the following expressions.

The expressions include, for example, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope.

Other examples of the expressions include, “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path”. Other examples of the expressions also include “a source (or a first terminal or the like) of a transistor is electrically connected to X through at least Z1 on a first connection path, the first connection path does not include a second connection path, the second connection path includes a connection path through the transistor, a drain (or a second terminal or the like) of the transistor is electrically connected to Y through at least Z2 on a third connection path, and the third connection path does not include the second connection path”, and “a source (or a first terminal or the like) of a transistor is electrically connected to X through at least Z1 on a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through at least Z2 on a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit configuration is defined by an expression similar to the above examples, a source (or a first terminal or the like) and a drain (or a second terminal or the like) of a transistor can be distinguished from each other to specify the technical scope.

Note that these expressions are only examples and one embodiment of the present invention is not limited to the expressions. Here, X, Y, Z1, and Z2 each denote an object (e.g., a device, an element, a circuit, a wiring, an electrode, a terminal, a conductive film, and a layer).

Even when independent components are electrically connected to each other in a circuit diagram, one component has functions of a plurality of components in some cases. For example, when part of a wiring also functions as an electrode, one conductive film functions as the wiring and the electrode. Thus, “electrical connection” in this specification includes in its category such a case where one conductive film has functions of a plurality of components.

This application is based on Japanese Patent Application Serial No. 2016-193458 filed with Japan Patent Office on Sep. 30, 2016, the entire contents of which are hereby incorporated by reference.

What is claimed is:

1. A display panel comprising:
a pixel comprising:
a first display element comprising a reflective film;
a second display element comprising a light-emitting element; and
a functional layer including a region between the first and second display elements,
wherein:
the functional layer comprises a pixel circuit electrically connected to the first and second display elements,
the first display element is configured to control intensity of light reflected by the reflective film having a shape not blocking light emitted from the second display element, and
the second display element is provided such that display using the second display element can be seen from part of a region where display using the first display element can be seen.

2. The display panel according to claim 1, wherein:
the pixel further comprises an optical element having a light-transmitting property and a covering film having light reflectivity,
the optical element includes a first region to which light is supplied, a second region partly in contact with the covering film, and a third region configured to emit part of the light,
the third region has an area smaller than or equal to the first region,
the covering film is configured to reflect the part of the light and supply the part of the light to the third region,
the reflective film having a shape not blocking light emitted from the third region, and
the second display element is configured to supply the light.

3. The display panel according to claim 2, wherein:
the optical element has an optical axis,
the optical axis passes through a center of each of the first and third regions, and
the second region includes an inclined portion with an inclination of 45° or more with respect to a plane orthogonal to the optical axis.

4. The display panel according to claim 2, further comprising a lens between the optical element and the second display element,
wherein:
the lens includes a material with a refractive index of 1.5 or more and 2.5 or less, and
the lens is a convex lens.

5. The display panel according to claim 1, wherein:
the pixel comprises:
a first conductive film electrically connected to the first display element;
a second conductive film partly overlapping with the first conductive film; and
an insulating film between the first and second conductive films, the insulating film has an opening,
the second conductive film is electrically connected to the first conductive film in the opening, and to the pixel circuit,
the second display element is electrically connected to the pixel circuit, and
the second display element is configured to emit light toward the insulating film.

6. The display panel according to claim 1, further comprising:
a display region comprising:
one group of pixels comprising the pixel;
another group of pixels comprising the pixel;
a scan line electrically connected to the one group of pixels; and
a signal line electrically connected to the another group of pixels,
wherein:
the pixels of the one group are arranged in a row direction,
the pixels of the another group are arranged in a column direction intersecting the row direction.

7. A display device comprising:
the display panel according to claim 1; and
a control portion,
wherein:
the control portion is configured to receive image data and control data, to generate first data and/or second data on the basis of the image data, and to supply the first data and the second data, and
the display panel is configured to receive the first data and the second data, to display a first image on the basis of the first data, and to display a second image on the basis of the second data.

8. An input/output device comprising:
an input portion comprising a sensing region; and
a display portion comprising the display panel according to claim 1,
wherein:
the input portion is configured to sense an object approaching the sensing region, and
the sensing region partly overlaps with the pixel.

9. The input/output device according to claim 8, wherein:
the sensing region comprises:
a control line configured to supply a control signal;
a sensor signal line configured to receive a sensor signal; and
a sensor element electrically connected to the control line and the sensor signal line,
the sensor element is configured to supply the sensor signal that varies in accordance with the control signal and a distance between a region overlapping with the pixel and an object approaching the region,
the sensor element comprises a first electrode including a first light-transmitting region overlapping with the pixel, and a second electrode including a second light-transmitting region overlapping with the pixel,
the first electrode is electrically connected to the control line,
the second electrode is electrically connected to the sensor signal line, and
the second electrode is located such that an electric field part of which is blocked by an object approaching the region overlapping with the pixel is generated between the first and second electrodes.

10. A data processing device comprising:
at least one of a keyboard, a hardware button, a pointing device, a touch sensor, an illuminance sensor, an imaging device, an audio input device, a viewpoint input device, and an attitude determination device; and
the display panel according to claim 1.
